(19) United States
(12) Patent Application Publication
(10) Pub. No.: US 2014/0222910 A1
(43) Pub. Date: Aug. 7, 2014

(54) CONTENT DELIVERY SYSTEM WITH DESTINATION MANAGEMENT MECHANISM AND METHOD OF OPERATION THEREOF

(71) Applicant: SAMSUNG ELECTRONICS CO., LTD., Gyeonggi-Do (KR)

(72) Inventors: Nicolai Munk Petersen, San Jose, CA (US); Guy Bar-Nahum, San Francisco, CA (US)

(73) Assignee: SAMSUNG ELECTRONICS CO., LTD., Gyeonggi-Do (KR)

(21) Appl. No.: 13/759,483

(22) Filed: Feb. 5, 2013

(51) Int. Cl. H04L 29/08

(52) U.S. Cl. CPC H04L 67/22
USPC 709/204

(57) ABSTRACT

A method of operation of a content delivery system includes: detecting a user's behavior; calculating an adjustment weight based on the user's behavior; selecting a content destination based on the adjustment weight for sharing a content to the content destination; and generating a destination group based on the content destination for displaying on a device.

### TECHNICAL FIELD

An embodiment of the present invention relates generally to a content delivery system, and more particularly to a system for destination management mechanism.

### BACKGROUND

Modern portable consumer and industrial electronics, especially client devices such as navigation systems, cellular phones, portable digital assistants, and combination devices, are providing increasing levels of functionality to support modern life including personalized content services. Research and development in the existing technologies can take a myriad of different directions.

As users become more empowered with the growth of personalized content service devices, new and old paradigms begin to take advantage of this new device space. There are many technological solutions to take advantage of this new device location opportunity. One existing approach is to evaluate user profile and location information to provide personalized content through a mobile device such as a cell phone, a smart phone, or a personal digital assistant.

Personalized content services allow users to create, transfer, store, and/or consume information in order for users to create, transfer, store, and consume in the “real world.” One such use of personalized content services is to efficiently transfer or guide users to the desired product or service.

Content delivery system and personalized content services enabled systems have been incorporated in automobiles, notebooks, handheld devices, and other portable products. Today, these systems aid users by incorporating available, real-time relevant information, such as advertisement, entertainment, local businesses, or other points of interest (POI).

Thus, a need still remains for a content delivery system with a destination management mechanism. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a method of operation of a content delivery system including: detecting a user's behavior; calculating an adjustment weight based on the user's behavior; selecting a content destination based on the adjustment weight for sharing a content to the content destination; and generating a destination group based on the content destination for displaying on a device.

An embodiment of the present invention provides a method of operation of a content delivery system including: detecting a user's behavior; calculating an adjustment weight based on the user's behavior; setting a grouping threshold based on the user's behavior; selecting a content destination based on the adjustment weight, the grouping threshold, or a combination thereof for sharing a content to the content destination; and generating a destination group based on the content destination for displaying on a device.

An embodiment of the present invention provides a content delivery system, including: a dispatcher module for detecting a user's behavior; a trainer module, coupled to the dispatcher module, for calculating an adjustment weight based on the user's behavior; a destination selector module, coupled to the trainer module for selecting a content destination based on the adjustment weight for sharing a content to the content destination; and a grouping module, coupled to the destination selector module, for generating a destination group based on the content destination for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a content delivery system with destination management mechanism in an embodiment of the present invention.

FIG. 2 is a first example of a content management view of the first device.

FIG. 3 is a second example of the content management view of the first device.

FIG. 4 is a third example of the content management view of FIG. 2 of the first device.

FIG. 5 is a fourth example of the content management view of the first device.

FIG. 6A is a fifth example of the content management view of the first device.

FIG. 6B is a further example of the gesture type of FIG. 6A of the pinching gesture changing the destination dimension of FIG. 5.

FIG. 7 is a sixth example of the content management view of FIG. 2 of the first device.

FIG. 8 is an example of the content delivery system interacting with the content destination representing the SNS account within a user's social network.

FIG. 9 is an example of the content delivery system interacting with the content destination via the communication path.

FIG. 10 is an exemplary block diagram of the content delivery system.

FIG. 11 is a control flow of the content delivery system.

FIG. 12 is the discovery module discovering the content destination of FIG. 2 for sharing the content of FIG. 2.

FIG. 13 is a flow chart of a method of operation of the content delivery system in an embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the embodiment of the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing figures. Similarly, although the views in the drawings for ease of description generally show similar orientations, this depiction in the figures. is arbitrary for the most part. Generally, the invention can be operated in any orientation. The embodiments have been numbered first embodiment, second embodiment, etc. as a matter of descriptive convenience and are not intended to have any other significance or provide limitations for the present invention. Where multiple embodiments are disclosed and described having some features in common, for clarity and ease of illustration, description, and comprehension thereof, similar and like features one to another will ordinarily be described with similar reference numerals.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

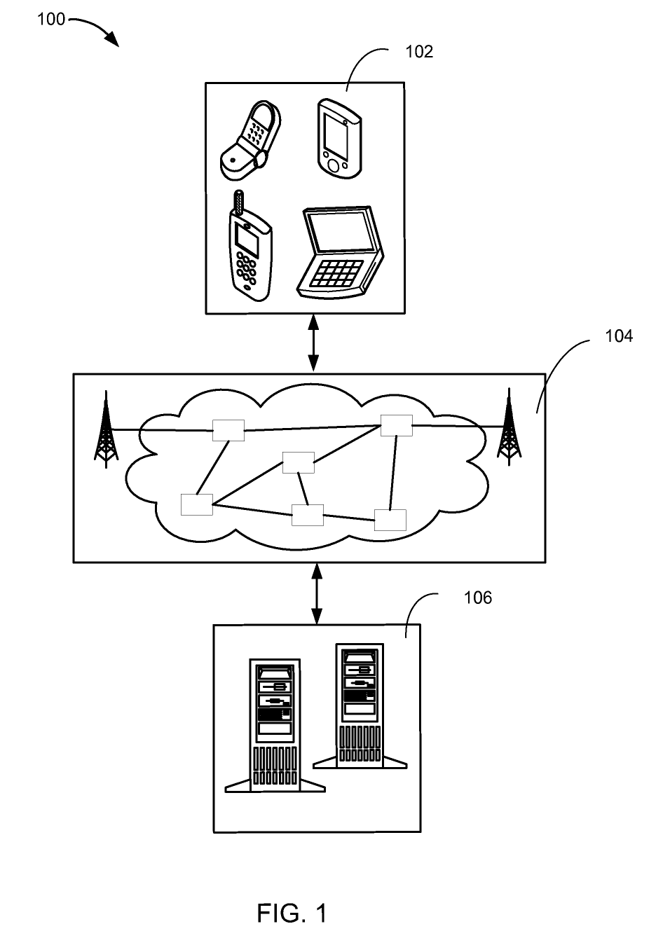

Referring now to FIG. 1, therein is shown a content delivery system 100 with destination management mechanism in an embodiment of the present invention. The content delivery system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, a notebook computer, automotive telematic content delivery system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the content delivery system 100 is described with the first device 102 as a mobile computing device, although it is understood that the first device 102 can be different types of computing devices. For example, the first device 102 can also be a non-mobile computing device, such as a server, a server farm, or a desktop computing device.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Palm Centro™, Samsung Galaxy™, or Moto Q Global™.

For illustrative purposes, the content delivery system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the content delivery system 100 is shown with the second device 106 and the first device 102 as end points of the communication path 104, although it is understood that the content delivery system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), near field communication (NFC), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

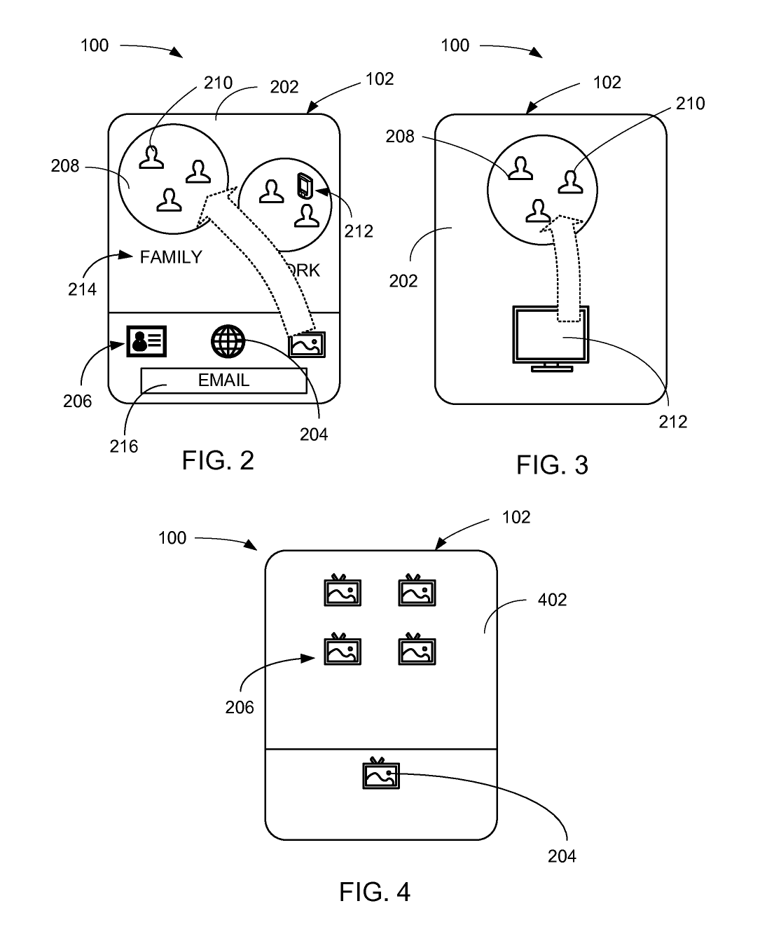

Referring now to FIG. 2, therein is shown a first example of a content management view 202 of the first device 102. The content management view 202 can represent a display interface for the first device 102 for the user to interact with the content delivery system 100 to share a content 204. The content management view 202 can display the content 204 to be shared by the content delivery system 100. The content 204 can have a variety of a content type 206. The content type 206 can represent a category of the content 204. For example, the content type 206 can include a digital file, such as digital video, digital picture, audio file, application, or a combination thereof.

The content management view 202 can display a destination group 208. The destination group 208 is defined as an arrangement of a content destination 210. The content destination 210 is defined a target for the content delivery system 100 to share the content 204. For example, the content destination 210 can include an electronic device, an email account, a social networking service (SNS) account, or a combination thereof. Examples of SNS can include Facebook™, LinkedIn™, or Google+™.

The destination group 208 can include a plurality of the content destination 210 with a plurality of a destination type 212. For example, the destination type 212 can represent a category of the content destination 210. For a specific example, the category can include the electronic device, the email account, the social networking service (SNS) account, or a combination thereof.

The destination group 208 can be labeled with a group tag 214. The group tag 214 can represent a classification of the destination group 208. For example, the group tag 214 can represent “family” for labeling the destination group 208. For a specific example, the content 204 representing the digital photo can be shared to the destination group 208 with the group tag 214 of “family.”

A delivery method 216 can represent a mode for delivering the content 204 to the content destination 210, the destination group 208, or a combination thereof. For example, the delivery method 216 can include email, short message service (SMS), multimedia messaging service (MMS), SNS message, file transport protocol (FTP), Real-time Transport Protocol (RTP), or a combination thereof.

Referring now to FIG. 3, therein is shown a second example of the content management view 202 of the first device 102. For example, the content delivery system 100 can add a variety of the destination type 212 for the content destination 210 into a same instance of the destination group 208.

For a specific example, the destination group 208 can initially include the content destination 210 with the destination type 212 of SNS account. The content delivery system 100 can include the content destination 210 with the destination type 212 of the electronic device, such as a high definition television (HD TV), into the destination group 208.

Referring now to FIG. 4, therein is shown a third example of the content management view 202 of FIG. 2 of the first device 102. For example, the content delivery system 100 can customize the sharing of the content 204 with the content destination 210 of FIG. 2 using a content interaction interface 402 of the content management view 202. The content interaction interface 402 can represent the content management view 202 that allows the user, the content delivery system 100, or a combination thereof to arrange the content 204 for sharing with the content destination 210. For a specific example, the content interaction interface 402 can display a plurality of the content 204 sharing a same instance of the content type 206. More specifically, the content 204 can be organized based on the content type 206 representing the digital photographs.

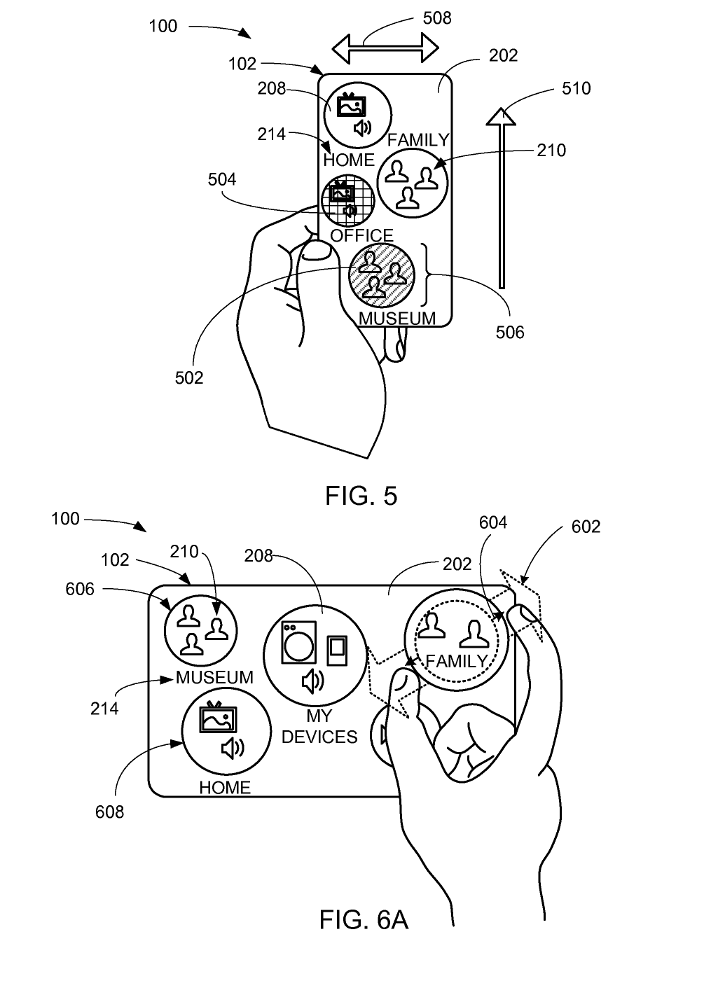

Referring now to FIG. 5, therein is shown a fourth example of the content management view 202 of the first device 102. The content destination 210, the destination group 208, or a combination thereof can have a destination characteristic 502. The destination characteristic 502 is defined as an attribute of the content destination 210, the destination group 208, or a combination thereof. For example, the destination characteristic 502 can include a destination appearance 504, a destination dimension 506, a destination position 508, or a combination thereof.

The destination appearance 504, the destination dimension 506, the destination position 508, the group tag 214 can impact a destination priority 510. The destination priority 510 can represent a significance level for sharing the content 204 of FIG. 2 by the content delivery system 100. The destination priority 510 can include an importance level, a relevance level, or a combination thereof. More specifically, the destination priority 510 can signify whether the content destination 210, the destination group 208, or a combination thereof can receive the content 204 or not. For a different example, the destination priority 510 can determine the order for a plurality of the destination group 208 to receive the content 204. For another example, the destination priority 510 can determine whether the content destination 210 can be included in the destination group 208.

The destination appearance 504 can represent a visual depiction of the content destination 210, the destination group 208, or a combination thereof displayed on the content management view 202. For example, the destination appearance 504 can include color, opacity, or a combination thereof. For a specific example, the destination appearance 504 with the color “green” can represent a highest of the destination priority 510 for sharing the content 204. With the destination appearance 504 of “green,” the content destination 210 in the destination group 208 can be set to receive all types of the content type 206 of FIG. 2 including a confidential document. For further example, the destination group 208 with the destination appearance 504 of “green” can receive the content 204 before the destination group 208 with the destination appearance 504 that is not “green.”

In contrast, the destination appearance 504 with the color “red” can represent a lowest of the destination priority 510 for sharing the content 204. With the destination appearance 504 of “red,” the content destination 210 in the destination group 208 can be set to not receive certain type of the content type 206, such as the confidential document. As the destination appearance 504 changes, the appearance of the content destination 210 within the destination group 208 can change consistently with the change of the destination appearance 504. The content delivery system 100 can change the destination appearance 504 to manipulate the destination priority 510 of the content destination 210, the destination group 208, or a combination thereof for receiving the content 204. Details regarding the manipulation will be discussed below.

For another example, the destination dimension 506 is defined as a spatial property of the content destination 210, the destination group 208, or a combination thereof. For example, the destination dimension 506 can include a boundary size of the destination group 208, a boundary shape of the destination group 208, or a combination thereof. For a specific example, the boundary shape can include a uniform shape, such as a circle or a square, and a non-uniform shape. For FIG. 5, the destination dimension 506 of the destination group 208 can be a circle.

For a specific example, if one instance of the destination group 208 can have the destination dimension 506 that is larger than another instance of the destination group 208, the one instance with the larger of the destination dimension 506 can have the higher of the destination priority 510. Further, as the size of the destination dimension 506 changes, the size of the content destination 210 appeared on the content management view 202 can change proportionally. For a specific example, if the destination dimension 506 increases in size, the content destination 210 in the destination group 208 can also increase in size proportionally. The content delivery system 100 can change the destination dimension 506 to manipulate the destination priority 510 of the content destination 210, the destination group 208, or a combination thereof for receiving the content 204. Details regarding the manipulation will be discussed below.

For another example, the destination position 508 is defined as a location of the content destination 210, the destination group 208, or a combination thereof appearing on the content management view 202. For example, the destination group 208 with the group tag 214 of “home” can be vertically above the destination group 208 with the group tag 214 of “office.” The destination position 508 of the destination group 208 on the content management view 202 can represent the destination priority 510 of the destination group 208 to the user of the content delivery system 100. For example, the destination group 208 with the destination position 508 of the top most area of the content management view 202 can represent the destination group 208 with the highest of the destination priority 510.

For a different example, an orientation of the content management view 202 can impact the destination position 508. More specifically, in FIG. 5, the content management view 202 can be vertical by having a long edge of the content management view 202 perpendicular to a short edge of the content management view 202. If an orientation of the content management view 202 is vertical, the destination group 208 with the destination position 508 of the top most area of the content management view 202 can represent the destination group 208 with the highest of the destination priority 510.

In contrast, if the orientation of the content management view 202 is horizontal with the short edge perpendicular to the long edge, the destination group 208 with the destination position 508 of the most left area of the content management view 202 can represent the destination group 208 with the highest of the destination priority 510. The content delivery system 100 can change the destination position 508 to manipulate the destination priority 510 of the content destination 210, the destination group 208, or a combination thereof for receiving the content 204. Details regarding the manipulation will be discussed below.

For another example, the group tag 214 can change the destination priority 510 for sharing the content 204 by the content delivery system 100. For a specific example, the destination group 208 with the group tag 214 of “work” can receive the content 204 related to work email. In contrast, the destination group 208 with the group tag 214 of “family” can receive the content 204 related to digital photo from a family member but not the content 204 related to work email.

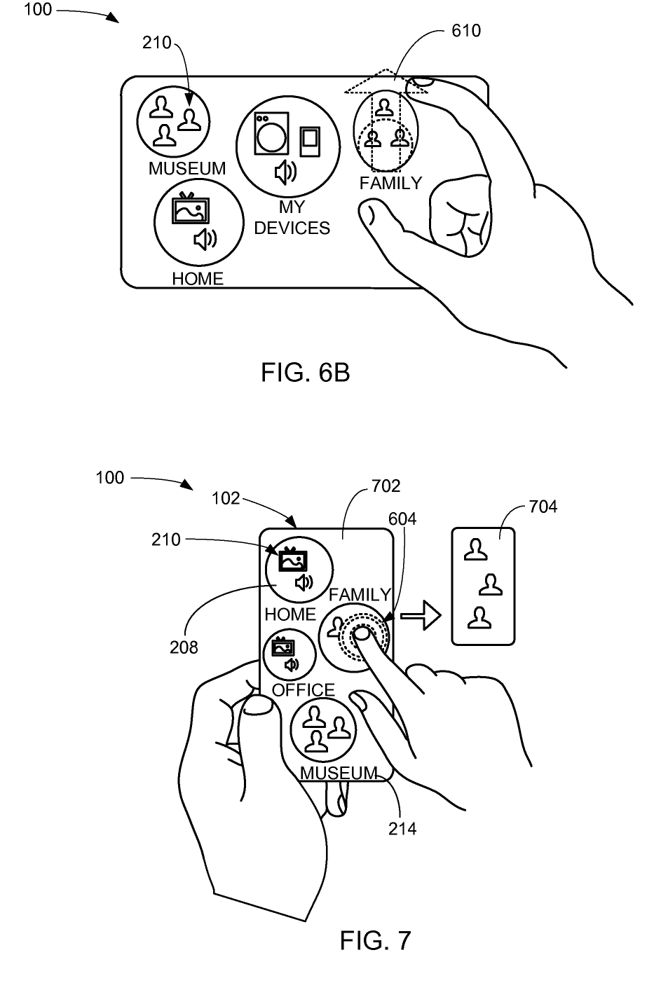

Referring now to FIG. 6A, therein is shown a fifth example of the content management view 202 of the first device 102. The content delivery system 100 can recognize a user's behavior 602 and reflect the result of the user's behavior 602 on the content management view 202. The user's behavior 602 is defined as a type of interaction recognized by the content delivery system 100 for the user using the first device 102. The type of interaction can include a gesture type 604, an activity pattern 606, or a combination thereof.

The gesture type 604 is defined as a type of entry to the content management view 202. For example, the gesture type 604 can include user's manual entry to the content management view 202. More specifically, the gesture type 604 can include a pinching gesture, a press gesture, a shaking gesture, a throwing gesture, a fling gesture, a squeeze gesture, a dragging gesture, or a combination thereof. The pinch gesture can represent a motion where the user uses two or more fingers to perform a motion of squeezing or expanding by contacting a surface of the content management view 202.

The press gesture can represent the motion where the user presses down on the surface of the content management view 202. Duration of time for pressing down, for example, can range from 1 second to 3 seconds for a long press down, which can be longer than touching the surface with a tap. For a different example, a short press down can be less than or equal to 250 milliseconds. The shaking gesture can represent the motion where the user sways the first device 102 with short, quick, irregular vibratory movement. For example, the duration of short, quick irregular vibratory movement can be from 250 milliseconds to 1 second. For further example, the range of motion for the shaking gesture can be greater than or equal to 20 millimeter. The throwing gesture can represent the motion where the user performs the motion of propelling the first device 102 but does not actually release the first device 102.

The fling gesture can represent the motion where the user swipes the surface rapidly towards one direction having contact with the content management view 202. The squeeze gesture can represent the motion where the user squeezes the periphery of the first device 102. For example, the duration of the squeeze can be from 500 milliseconds to 3 seconds. The periphery of the first device 102 can exclude the content management view 202. For example, the gesture type 604 can be recognized as a squeeze if the periphery of first device 102 can receive a force at more than one location for a duration longer than two seconds.

The dragging gesture can represent the motion where the user drags the content destination 210, the destination group 208, or a combination thereof to move the content destination 210, the destination group 208, or a combination thereof to a different location within the content management view 202. More specifically, the content management view 202 can recognize the user sustaining the contact on the content destination 210, the destination group 208, or a combination thereof to change the destination position 508 of FIG. 5 on the content management view 202.

For example, in FIG. 6A, the content management view 202 can recognize the gesture type 604 of the pinching gesture. The user can perform the pinching gesture to change the destination dimension 506 of FIG. 5. The change can include expanding or shrinking the destination dimension 506. For a specific example, the original size of the destination dimension 506 can be shown as a dotted circle. The pinching gesture can expand the destination dimension 506 to enlarge the size of the destination group 208 to the extent shown as a solid circle.

For a different example, the user can activate the content management view 202 with the fling gesture. More specifically, an activation of the content management view 202 can represent invoking the first device 102 to display the content destination 210, the destination group 210, or a combination thereof. For another example, the user can perform the squeezing gesture to change the delivery method mode 216 of FIG. 2. More specifically, by performing the squeezing gesture, the delivery method mode 216 can change from MMS to RTP.

The activity pattern 606 is defined as an interaction record using the content delivery system 100. The activity pattern 606 can include a grouping pattern 608. The grouping pattern 608 can represent how the content destination 210 was grouped in the destination group 208. For example, in FIG. 6, the content management view 202 can display a plurality of the destination group 208 with a plurality of the group tag 214, such as “family,” “my devices,” “home,” and “museum.”

More specifically, the destination group 208 of “my devices” can group the plurality of the content destination 210 representing portable computing devices, such as a tablet device, a smartphone device, or a laptop. The destination group 208 of “home” can represent the plurality of the content destination 210 representing the electronic device of a stationary computing device, such as the desktop computing device. More specifically, the stationary computing device can represent the electronic device not considered as a mobile device carried around by a person, a vehicle, or a combination thereof. The grouping pattern 608 can illustrate how the destination group 208 is organized to separate one instance of the destination type 212 of FIG. 2 from another instance of the destination type 212.

Referring now to FIG. 6B, therein is shown a further example of the gesture type 604 of FIG. 6A of the pinching gesture changing the destination dimension 506 of FIG. 5. The content delivery system 100 can select the content destination 210 based on a dimensional change vector 610. The dimensional change vector 610 is defined as a direction of change of the destination dimension 506.

The gesture type 604 can generate the dimensional change vector 610 to manipulate the destination dimension 506. The dimensional change vector 610 can include a variety of the direction of change in the destination dimension 506. For example, the dimensional change vector 610 can include an upward vertical expansion, a downward vertical expansion, a left horizontal expansion, a right horizontal expansion, or a combination thereof. An expansion can represent an enlargement of the destination dimension 506.

For a different example, the dimensional change vector 610 can include an upward vertical contraction, a downward vertical contraction, a left horizontal contraction, a right horizontal contraction, or a combination thereof. A contraction can represent the reduction in the boundary size of the destination dimension 506. For another example, the dimensional change vector 610 can include a diagonal expansion, a diagonal contraction, or a combination thereof.

For further example, the destination dimension 506 can change as a whole or in portion. More specifically, the dimensional change vector 610 of the right horizontal expansion of a square can expand a top side and a bottom side of the square to push out a right side away from a left side of the square to form a rectangle. However, the distance between the top side and the bottom side can remain unchanged.

For a specific example, the pinching gesture can expand the destination dimension 506 to enlarge the circle into an oval by expanding a side of the circle while maintaining the original shape of the circle on an opposite side. The dimensional change vector 610 can represent the upward vertical expansion of the circle. The pinching gesture of the upward vertical expansion can result in an inclusion of an older generation of a family member relative to the user while a downward vertical expansion can result in the inclusion of a younger generation of the family member relative to the user.

Referring now to FIG. 7, therein is shown a sixth example of the content management view 202 of FIG. 2 of the first device 102. The content management view 202 can include a group view 702 and an explosion view 704. The group view 702 can represent a default view of the content management view 202 for displaying the destination group 208 on the first device 102. The default view can also represent the content management view 202 initially viewed by the user after activating the first device 102. For example, the default view can display the content destination 210, the destination group 208, or a combination thereof. The explosion view 704 can represent a sub-view of the group view 702. For clarification, if the group view 702 can show the destination group 208, the explosion view 704 can show the content destination 210 within the destination group 208 but not the destination group 208 itself.

More specifically, the group view 702 can detect the gesture type 604 of the press gesture on the destination group 208 with the group tag 214 of “family.” In response, the content delivery system 100 can display the explosion view 704 on the content management view 202 instead of the group view 702. For further example, the explosion view 704 can display the content destination 210 within the destination group 208 of “family.” By displaying the content destination 210 on the explosion view 704, the content delivery system 100 can provide access to the content destination 210 to the user of the first device 102.

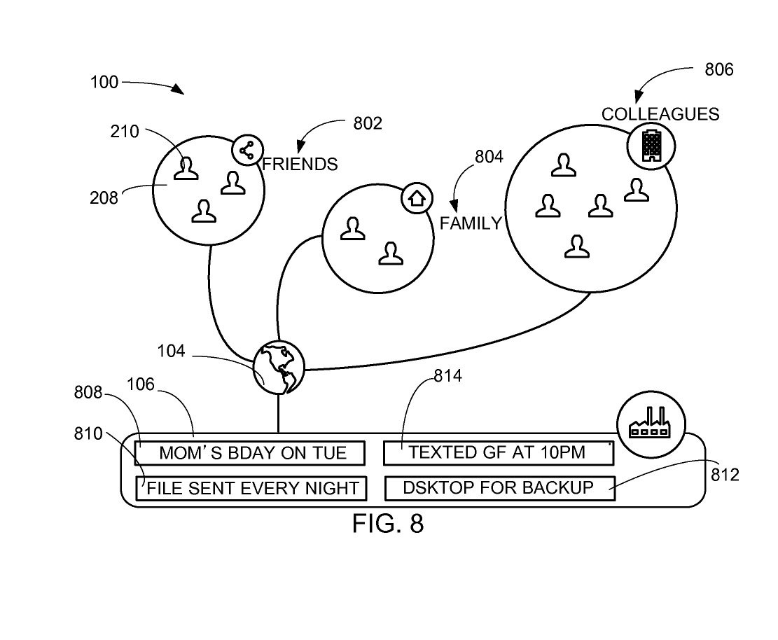

Referring now to FIG. 8, therein is shown an example of the content delivery system 100 interacting with the content destination 210 representing the SNS account within a user's social network. The content delivery system 100 can have the second device 106, via the communication path 104, interact with the content destination 210.

The interaction can be based on a social information 802 of the content destination 210. The social information 802 is defined as facts available within the SNS. For example, the facts can include a profile information 804, a social graph 806, an event information 808, or a combination thereof of the content destination 210.

The profile information 804 can represent data pertaining to members of the SNS. For example, the data can include the member's marital status, education background, work information, or a combination thereof. The user can be the member of SNS, such as LinkedIn™, and have the profile information 804 related to “work experience” stored within LinkedIn™.

The social graph 806 can represent information regarding a connection degree amongst the members within the SNS. The connection degree can represent a number of degrees that separates from one member to another member of the SNS. For example, the user can directly connect to his friend within LinkedIn™ but not directly connected to the friend's girlfriend. The connection degree between the user and the friend can be one degree of separation while the connection degree between the user and the user's girlfriend can be two degrees of separation.

The event information 808 can represent a date with significance to the user of the SNS. For example, the event information 808 can include birthdays, anniversaries, parties, meetings, gatherings, or a combination thereof.

The activity pattern 606 of FIG. 6A can include a content sharing pattern 810, a device usage pattern 812, a communication history 814, or a combination thereof. The content sharing pattern 810 can represent the record pertaining to how the content delivery system 100 shared the content 204 of FIG. 2 to the content destination 210. For example, the content delivery system 100 can share the content type 206 of FIG. 2 of a file, such as a digital photograph, to the content destination 210 every night.

The device usage pattern 812 is defined as the interaction record pertaining to a use of the content delivery system 100. For example, the device usage pattern 812 can include the frequency of usage of the content management view 202 of FIG. 2 by the user. For another example, the device usage pattern 812 can include a type of use of the first device 102 of FIG. 2, the content destination 210, or a combination thereof. For a specific example, the content destination 210 can represent a user's home desktop computing device. The device usage pattern 812 can show that the content delivery system 100 shared the content type 206 of FIG. 2 of digital photograph from the first device 102 to the content destination 210 for backing up the content 204.

The communication history 814 is defined as a transmission record between the first device 102 and the content destination 210. The communication history 814 can include a record for phone calls, text messages, SNS messages, instant message, file transferred record, or a combination thereof. For example, the communication history 814 can include a text message sent to user's girlfriend at 10 PM. For a different example, the communication history 814 can include an engagement duration between the first device 102 and the content destination 210, the destination group 208, or a combination thereof. More specifically, the engagement duration can represent a duration of time interacted between the first device 102 and the content destination 210.

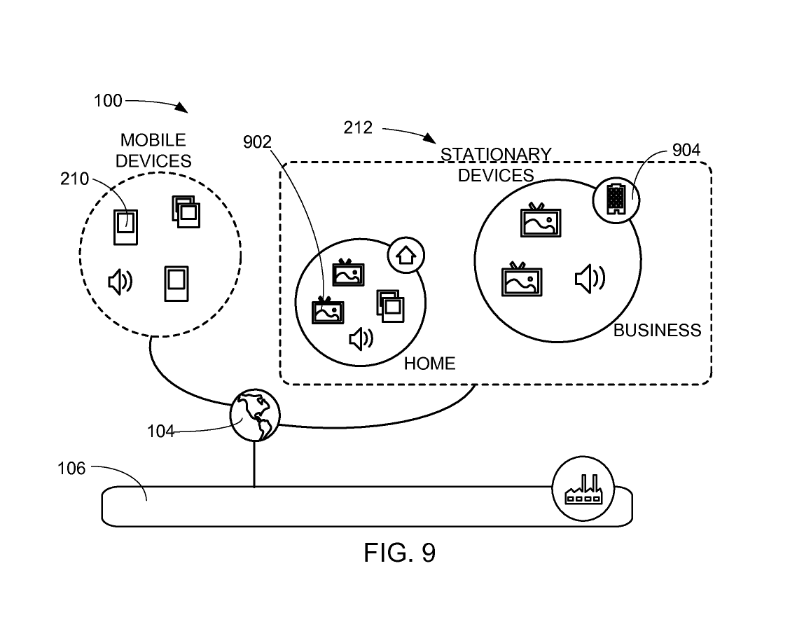

Referring now to FIG. 9, therein is shown an example of the content delivery system 100 interacting with the content destination 210 via the communication path 104. The second device 106 can interact with the plurality of the content destination 210.

As discussed previously, the content destination 210 can be classified by the destination type 212. For example, the category can include the electronic device, such as a mobile device or a stationary device. For a specific example, the mobile device can include the smartphone and the stationary device can include the desktop computing device.

The content destination 210 can include a destination status 902. The destination status 902 is defined as a condition of the content destination 210. For example, the content destination 210 can represent the electronic device. The condition of the electronic device can include “turned on” versus “turned off.” For a different example, the content destination 210 can represent the SNS account. The condition can include “authorized for access” versus “unauthorized for access.”

The content destination 210 can include a destination location 904. The destination location 904 is defined as a geographic location of the content destination 210. For example, the destination location 904 with the destination type 212 of the desktop computing device can be within a set physical location, such as home or office.

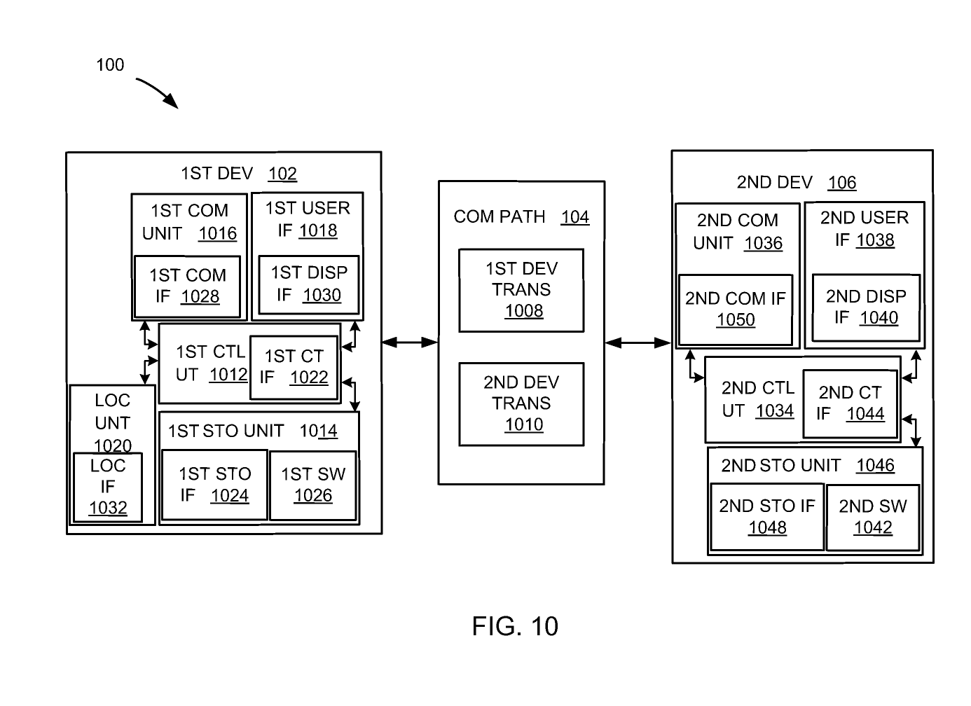

Referring now to FIG. 10, therein is an exemplary block diagram of the content delivery system 100. The content delivery system 100 can include the first device 102, the communication path 104, and the second device 106.

The first device 102 can communicate with the second device 106 over the communication path 104. The first device 102 can send information in a first device transmission 1008 over the communication path 104 to the second device 106. The second device 106 can send information in a second device transmission 1010 over the communication path 104 to the first device 102.

For illustrative purposes, the content delivery system 100 is shown with the first device 102 as a client device, although it is understood that the content delivery system 100 can have the first device 102 as a different type of device. For example, the first device 102 can be a server.

Also for illustrative purposes, the content delivery system 100 is shown with the second device 106 as a server, although it is understood that the content delivery system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of the present invention.

The first device 102 can include a first control unit 1012, a first storage unit 1014, a first communication unit 1016, a first user interface 1018, and a location unit 1020. The first control unit 1012 can include a first control interface 1022. The first control unit 1012 can execute a first software 1026 to provide the intelligence of the content delivery system 100. The first control unit 1012 can be implemented in a number of different manners. For example, the first control unit 1012 can be a processor, an embedded processor, a microprocessor, a hardware control logic, a hardware finite state machine (FSM), a digital signal processor (DSP), or a combination thereof. The first control interface 1022 can be used for communication between the first control unit 1012 and other functional units in the first device 102. The first control interface 1022 can also be used for communication that is external to the first device 102.

The first control interface 1022 can receive information from the other functional units or from external sources, or can transmit information to the other functional units or to external destinations. The external sources and the external destinations refer to sources and destinations physically separate to the first device 102.

The first control interface 1022 can be implemented in different ways and can include different implementations depending on which functional units or external units are being interfaced with the first control interface 1022. For example, the first control interface 1022 can be implemented with a pressure sensor, an inertial sensor, a microelectromechanical system (MEMS), optical circuitry, waveguides, wireless circuitry, wireline circuitry, or a combination thereof.

The location unit 1020 can generate location information, current heading, and current speed of the first device 102, as examples. The location unit 1020 can be implemented in many ways. For example, the location unit 1020 can function as at least a part of a global positioning system (GPS), an inertial navigation system, a cellular-tower location system, a pressure location system, or any combination thereof.

The location unit 1020 can include a location interface 1032. The location interface 1032 can be used for communication between the location unit 1020 and other functional units in the first device 102. The location interface 1032 can also be used for communication that is external to the first device 102.

The location interface 1032 can receive information from the other functional units or from external sources, or can transmit information to the other functional units or to external destinations. The external sources and the external destinations refer to sources and destinations physically separate to the first device 102.

The location interface 1032 can include different implementations depending on which functional units or external units are being interfaced with the location unit 1020. The location interface 1032 can be implemented with technologies and techniques similar to the implementation of the first control interface 1022.

The first storage unit 1014 can store the first software 1026. The first storage unit 1014 can also store the relevant information, such as advertisements, points of interest (POI), navigation routing entries, or any combination thereof.

The first storage unit 1014 can be a volatile memory, a nonvolatile memory, an internal memory, an external memory, or a combination thereof. For example, the first storage unit 1014 can be a nonvolatile storage such as non-volatile random access memory (NVRAM), Flash memory, disk storage, or a volatile storage such as static random access memory (SRAM).

The first storage unit 1014 can include a first storage interface 1024. The first storage interface 1024 can be used for communication between the location unit 1020 and other functional units in the first device 102. The first storage interface 1024 can also be used for communication that is external to the first device 102.

The first storage interface 1024 can receive information from the other functional units or from external sources, or can transmit information to the other functional units or to external destinations. The external sources and the external destinations refer to sources and destinations physically separate to the first device 102.

The first storage interface 1024 can include different implementations depending on which functional units or external units are being interfaced with the first storage unit 1014. The first storage interface 1024 can be implemented with technologies and techniques similar to the implementation of the first control interface 1022.

The first communication unit 1016 can enable external communication to and from the first device 102. For example, the first communication unit 1016 can permit the first device 102 to communicate with the second device 106 of FIG. 1, an attachment, such as a peripheral device or a computer desktop, and the communication path 104.

The first communication unit 1016 can also function as a communication hub allowing the first device 102 to function as part of the communication path 104 and not limited to be an end point or terminal unit to the communication path 104. The first communication unit 1016 can include active and passive components, such as microelectronics or an antenna, for interaction with the communication path 104.

The first communication unit 1016 can include a first communication interface 1028. The first communication interface 1028 can be used for communication between the first communication unit 1016 and other functional units in the first device 102. The first communication interface 1028 can receive information from the other functional units or can transmit information to the other functional units.

The first communication interface 1028 can include different implementations depending on which functional units are being interfaced with the first communication unit 1016. The first communication interface 1028 can be implemented with technologies and techniques similar to the implementation of the first control interface 1022.

The first user interface 1018 allows a user (not shown) to interface and interact with the first device 102. The first user interface 1018 can include an input device and an output device. Examples of the input device of the first user interface 1018 can include a keypad, a touchpad, soft-keys, a keyboard, a microphone, or any combination thereof to provide data and communication inputs.

The first user interface 1018 can include a first display interface 1030. The first display interface 1030 can include a display, a projector, a video screen, a speaker, or any combination thereof.

The first control unit 1012 can operate the first user interface 1018 to display information generated by the content delivery system 100. The first control unit 1012 can also execute the first software 1026 for the other functions of the content delivery system 100, including receiving location information from the location unit 1020. The first control unit 1012 can further execute the first software 1026 for interaction with the communication path 104 via the first communication unit 1016.

The second device 106 can be optimized for implementing the embodiment of the present invention in a multiple device embodiment with the first device 102. The second device 106 can provide the additional or higher performance processing power compared to the first device 102. The second device 106 can include a second control unit 1034, a second communication unit 1036, and a second user interface 1038.

The second user interface 1038 allows a user (not shown) to interface and interact with the second device 106. The second user interface 1038 can include an input device and an output device. Examples of the input device of the second user interface 1038 can include a keypad, a touchpad, soft-keys, a keyboard, a microphone, or any combination thereof to provide data and communication inputs. Examples of the output device of the second user interface 1038 can include a second display interface 1040. The second display interface 1040 can include a display, a projector, a video screen, a speaker, or any combination thereof.

The second control unit 1034 can execute a second software 1042 to provide the intelligence of the second device 106 of the content delivery system 100. The second software 1042 can operate in conjunction with the first software 1026. The second control unit 1034 can provide additional performance compared to the first control unit 1012.

The second control unit 1034 can operate the second user interface 1038 to display information. The second control unit 1034 can also execute the second software 1042 for the other functions of the content delivery system 100, including operating the second communication unit 1036 to communicate with the first device 102 over the communication path 104.

The second control unit 1034 can be implemented in a number of different manners. For example, the second control unit 1034 can be a processor, an embedded processor, a microprocessor, a hardware control logic, a hardware finite state machine (FSM), a digital signal processor (DSP), or a combination thereof.

The second control unit 1034 can include a second control interface 1044. The second control interface 1044 can be used for communication between the second control unit 1034 and other functional units in the second device 106. The second control interface 1044 can also be used for communication that is external to the second device 106.

The second control interface 1044 can receive information from the other functional units or from external sources, or can transmit information to the other functional units or to external destinations. The external sources and the external destinations refer to sources and destinations physically separate to the second device 106.

The second control interface 1044 can be implemented in different ways and can include different implementations depending on which functional units or external units are being interfaced with the second control interface 1044. For example, the second control interface 1044 can be implemented with a pressure sensor, an inertial sensor, a microelectromechanical system (MEMS), optical circuitry, waveguides, wireless circuitry, wireline circuitry, or a combination thereof.

A second storage unit 1046 can store the second software 1042. The second storage unit 1046 can also store the relevant information, such as advertisements, points of interest (POI), navigation routing entries, or any combination thereof. The second storage unit 1046 can be sized to provide the additional storage capacity to supplement the first storage unit 1014.

For illustrative purposes, the second storage unit 1046 is shown as a single element, although it is understood that the second storage unit 1046 can be a distribution of storage elements. Also for illustrative purposes, the content delivery system 100 is shown with the second storage unit 1046 as a single hierarchy storage system, although it is understood that the content delivery system 100 can have the second storage unit 1046 in a different configuration. For example, the second storage unit 1046 can be formed with different storage technologies forming a memory hierarchal system including different levels of caching, main memory, rotating media, or off-line storage.

The second storage unit 1046 can be a volatile memory, a nonvolatile memory, an internal memory, an external memory, or a combination thereof. For example, the second storage unit 1046 can be a nonvolatile storage such as non-volatile random access memory (NVRAM), Flash memory, disk storage, or a volatile storage such as static random access memory (SRAM).

The second storage unit 1046 can include a second storage interface 1048. The second storage interface 1048 can be used for communication between the location unit 1020 and other functional units in the second device 106. The second storage interface 1048 can also be used for communication that is external to the second device 106.

The second storage interface 1048 can receive information from the other functional units or from external sources, or can transmit information to the other functional units or to external destinations. The external sources and the external destinations refer to sources and destinations physically separate to the second device 106.

The second storage interface 1048 can include different implementations depending on which functional units or external units are being interfaced with the second storage unit 1046. The second storage interface 1048 can be implemented with technologies and techniques similar to the implementation of the second control interface 1044.

The second communication unit 1036 can enable external communication to and from the second device 106. For example, the second communication unit 1036 can permit the second device 106 to communicate with the first device 102 over the communication path 104.

The second communication unit 1036 can also function as a communication hub allowing the second device 106 to function as part of the communication path 104 and not limited to be an end point or terminal unit to the communication path 104. The second communication unit 1036 can include active and passive components, such as microelectronics or an antenna, for interaction with the communication path 104.

The second communication unit 1036 can include a second communication interface 1050. The second communication interface 1050 can be used for communication between the second communication unit 1036 and other functional units in the second device 106. The second communication interface 1050 can receive information from the other functional units or can transmit information to the other functional units.

The second communication interface 1050 can include different implementations depending on which functional units are being interfaced with the second communication unit 1036. The second communication interface 1050 can be implemented with technologies and techniques similar to the implementation of the second control interface 1044.

The first communication unit 1016 can couple with the communication path 104 to send information to the second device 106 in the first device transmission 1008. The second device 106 can receive information in the second communication unit 1036 from the first device transmission 1008 of the communication path 104.

The second communication unit 1036 can couple with the communication path 104 to send information to the first device 102 in the second device transmission 1010. The first device 102 can receive information in the first communication unit 1016 from the second device transmission 1010 of the communication path 104. The content delivery system 100 can be executed by the first control unit 1012, the second control unit 1034, or a combination thereof.

For illustrative purposes, the second device 106 is shown with the partition having the second user interface 1038, the second storage unit 1046, the second control unit 1034, and the second communication unit 1036, although it is understood that the second device 106 can have a different partition. For example, the second software 1042 can be partitioned differently such that some or all of its function can be in the second control unit 1034 and the second communication unit 1036. Also, the second device 106 can include other functional units not shown in FIG. 10 for clarity.

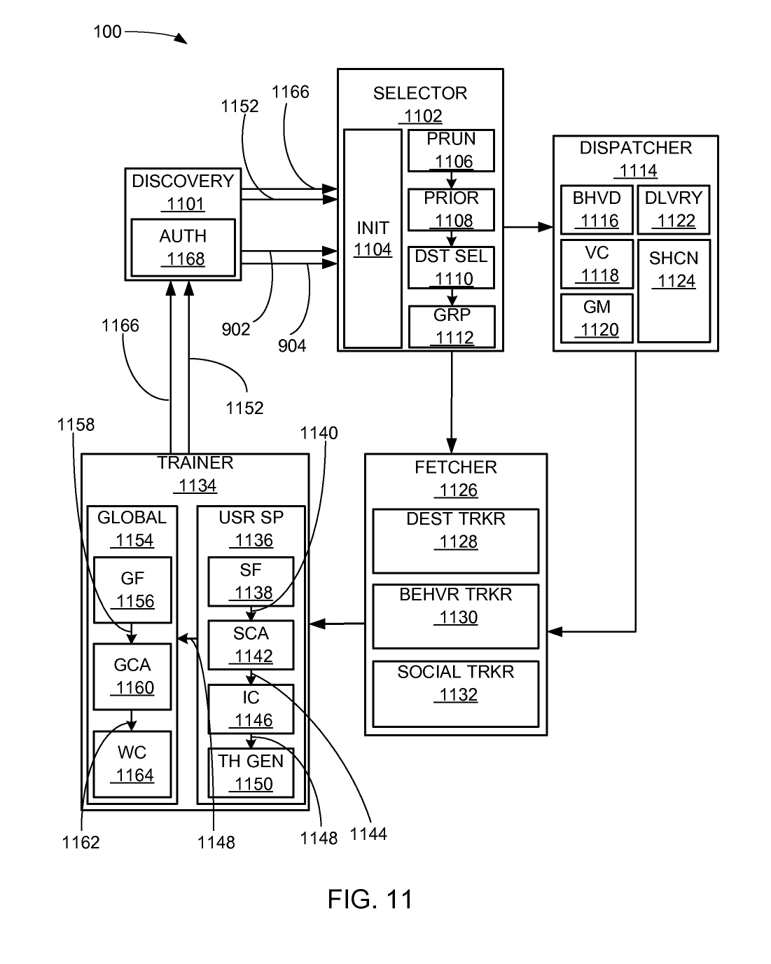

Referring now to FIG. 11, therein is shown a control flow of the content delivery system 100. The content delivery system 100 can include a discovery module 1101. The discovery module 1101 discovers the content destination 210 of FIG. 2. For example, the discovery module 1101 can discover the content destination 210 for sharing the content 204 of FIG. 2. Details regarding the discovery module 1101 will be discussed below.

The content delivery system 100 can include a selector module 1102, which can be coupled to the discovery module 1101. The selector module 1102 determines the content destination 210 of FIG. 2, the destination group 208 of FIG. 2, or a combination thereof. For example, the selector module 1102 can determine the content destination 210, the destination group 208, or a combination thereof for sharing the content 204.

The selector module 1102 can include an initialization module 1104. The initialization module 1104 determines the content destination 210, the destination group 208, or a combination thereof. For example, the initialization module 1104 can determine the content destination 210, the destination group 208, or a combination thereof to share the content 204 when the content delivery system 100 is invoked for the first time. For example, the initialization module 1104 can determine the content destination 210 based on the content destination 210 discovered by the discovery module 210.

The selector module 1102 can include a pruning module 1106, a priority module 1108, a destination selector module 1110, and a grouping module 1112. Details regarding each of the modules will be discussed below.

The content delivery system 100 can include a dispatcher module 1114. The dispatcher module 1114 can be coupled to the selector module 1102. The dispatcher module 1114 displays the content destination 210, the destination group 208, or a combination thereof. For example, the dispatcher module 1114 can display the content destination 210, the destination group 208, or a combination thereof determined by the selector module 1102.

The dispatcher module 1114 can display the content destination 210, the destination group 208 of FIG. 2, or a combination thereof in a number of ways. For example, the dispatcher module 1114 can display the content destination 210, the destination group 208, or a combination thereof in the content management view 202 of FIG. 2.

The dispatcher module 1114 can include a behavior detector module 1116. The behavior detector module 1116 detects the user's behavior 602 of FIG. 6A. For example, the behavior detector module 1116 can recognize the gesture type 604 of FIG. 6 performed on the first device 102 of FIG. 1.

For a specific example, the behavior detector module 1116 can recognize the gesture type 604 of the squeeze gesture when the periphery of first device 102 receives a force at more than one location for a duration greater than two seconds. For a different example, the behavior detector module 1116 can recognize the gesture type 604 of the press gesture when the content management view 202 receives a force pressing down onto the content management view 202 for the duration greater than one second.

For another example, the behavior detector module 1116 can recognize the pinch gesture generating the dimensional change vector 610 of FIG. 6B by exerting the right horizontal contraction movement to the destination dimension 506 of FIG. 5. More specifically, the behavior detector module 1116 can detect the dimensional change vector 610 of the right horizontal contraction for reducing the boundary size of the destination group 208 from the left hand side of the destination dimension 506.

The dispatcher module 1114 can include a view changer module 1118. The view changer module 1118 changes the content management view 202 displayed on the first device 102. For example, the view changer module 1118 can change the content management view 202 to the content interaction interface 402 of FIG. 4 based on recognizing the gesture type 604 of the fling gesture by detecting a quick swipe on the content management view 202. For a different example, the view changer module 1118 can change the content management view 202 into the group view 702 of FIG. 7 and the explosion view 704 of FIG. 7 based on recognizing the gesture type 604 of the press gesture.

For another example, the view changer module 1118 can change the destination characteristic 502 of FIG. 5. For a specific example, the view changer module 1118 can change the destination dimension 506 based on the gesture type 604 of the pinching gesture. More specifically, the view changer module 1118 can increase the destination dimension 506 of the destination group 208 based on the pinching gesture of expand. As a result, the boundary size of the destination group 208 can expand. For another example, the view changer module 1118 can change the destination position 508 of FIG. 5 based on the gesture type 604 of the dragging gesture. More specifically, the view changer module 1118 can relocate the content destination 210 by dragging the content destination 210 from the left hand side of the content management view 202 to the right hand side of the content management view 202.

The dispatcher module 1114 can include a group manipulator module 1120. The group manipulator module 1120 generates the destination group 208. For example, the group manipulator module 1120 can generate the destination group 208, update the destination group 208, or a combination thereof based on the user's behavior 602. For a specific example, the user can drag the content destination 210 representing “mom” to the content destination 210 representing “dad.” When two instances of the content destination 210 overlaps each other, the user can release the content destination 210 dragged. Both instances of the content destination 210 can have the destination type 212 of FIG. 2 of “family.” As a result, the group manipulator module 1120 can generate the destination group 208 with the group tag 214 of FIG. 2 of “family.”

For a different example, the destination group 208 can already include two instances of the content destination 210. The user can drag another instance of the content destination 210 to the destination group 208 and release the content destination 210 dragged once the content destination 210 overlaps the destination group 208. After the release, the group manipulator module 1120 can update the destination group 208 to include three instances of the content destination 210. Details regarding the generation of the destination group 208 and labeling with the group tag 214 will be discussed below.

The dispatcher module 1114 can include a delivery module 1122. The delivery module 1122 delivers the content 204. For example, the delivery module 1122 can deliver the content 204 to the content destination 210, the destination group 208, or a combination thereof based on the delivery method 216 of FIG. 2. For further example, the delivery module 1122 can deliver the content 204 based on the gesture type 604.

For a specific example, the delivery module 1122 can deliver the content 204 of Microsoft Word™ via the delivery method 216 of email based on the gesture type 604 of the dragging gesture. More specifically, the delivery module 1122 can recognize the content 204 being dragged and released when the content 204 overlaps with the destination group 208 with the group tag 214 of “work.” Once released, the delivery module 1122 can share the content 204 via email to the destination group 208. For a different example, the delivery module 1122 can deliver the content 204 of the mp3 audio file via MMS based on the gesture type 604 of the throwing gesture.

The dispatcher module 1114 can include a sharing configurator module 1124. Details regarding the sharing configurator module 1124 will be discussed below.

The content delivery system 100 can include a fetcher module 1126. The fetcher module 1126 tracks data pertaining to determining the content destination 210. For example, the fetcher module 1126 can track the destination status 902 of FIG. 9.

The fetcher module 1126 can include a destination tracker module 1128. The destination tracker module 1128 tracks the content destination 210. For example, the destination tracker module 1128 can track the destination status 902, the destination type 212 of FIG. 2, the destination location 904 of FIG. 9, or a combination thereof.

The destination tracker module 1128 can track the content destination 210 in a number of ways. For example, the destination tracker module 1128 can monitor the destination status 902 after the discovery module 1101 discovered the content destination 210. The destination tracker module 1128 can communicate via the first control interface 1022 of FIG. 10 with the content destination 210 to determine the availability by checking the destination status 902 periodically by sending the request for connection and by receiving the response back. The destination tracker module 1128 can track the content destination 210 similarly to the discovery module 1101.

For a different example, the destination tracker module 1128 can track the destination type 212 of the content destination 210. For example, out of the plurality of the content destination 210, the destination type 212 of the mobile device can be selected for sharing the content 204 while the destination type 212 of the stationary device was not. The destination tracker module 1128 can track that the content 204 was shared with the destination type 212 of the mobile device.

For another example, the destination tracker module 1128 can track the destination location 904 via the location unit 1020 of FIG. 10. The destination tracker module 1128 can track the destination location 904 based on monitoring the physical location of the content destination 210. The destination tracker module 1128 can track the destination location 904 similarly to the discovery module 1101.

For a different example, the destination tracker module 1128 can track the destination dimension 506 based on changes in the boundary size for the destination group 208 after the boundary has been expanded or shrunk. For another example, the destination tracker module 1128 can track the destination position 508 based on where the content destination 210, the destination group 208, or a combination thereof is located on the content management view 202. For a different example, the destination tracker module 1128 can track the destination appearance 504 of FIG. 5 based on changes in the visual depiction of the destination group 208 displayed on the content management view 202. For another example, the destination tracker module 1128 can track the group tag 214 based on the changes in the labeling of the destination group 208.

For further example, the destination tracker module 1128 can track the dimensional change vector 610 of FIG. 6B. The gesture type 604 can be the pinch gesture. As illustrated in FIG. 6B, the user can expand the top side of the circle to expand the destination dimension 506 to form the oval from the circle. More specifically, the destination tracker module 1128 can track the dimensional change vector 610 of the upward vertical expansion to expand the destination dimension 506 of the circle into the oval.

The fetcher module 1126 can include a behavior tracker module 1130. The behavior tracker module 1130 tracks and keeps record of the user's behavior 602 performed on the first device 102. For example, the behavior tracker module 1130 can track the activity pattern 606 of FIG. 6A.

The behavior tracker module 1130 can track the user's behavior 602 in a number of ways. For example, the behavior tracker module 1130 can track the gesture type 604 used for sharing the content 204. For a specific example, the behavior tracker module 1130 can track that the gesture type 604 of the fling gesture to share the content type 206 of FIG. 2 of a digital photograph with the destination group 208 with the group tag 214 of “friend.”

For a different example, the behavior tracker module 1130 can track the grouping pattern 608 of FIG. 6A, the content sharing pattern 810 of FIG. 8, the communication history 814 of FIG. 8, or a combination thereof. For a specific example, the behavior tracker module 1130 can track the grouping pattern 608 based on the social information 802 of FIG. 8. For example, the plurality of the content destination 210 sharing the profile information 804 of FIG. 8 of “Stanford University” can be grouped as the destination group 208 with the group tag 214 of “Stanford University.” The behavior tracker module 1130 can track the grouping pattern 608 of the content destination 210 based on the number of the content destination 210 having the same instances of the profile information 804.

For another example, the behavior tracker module 1130 can track the content sharing pattern 810 based on the content type 206 shared to the content destination 210, the destination group 208, or a combination thereof. For example, the content type 206 representing the mp3 audio file can be shared to the destination group 208 with the group tag 214 of “friend.” For a different example, the content 204 representing a portable document format (PDF) can be shared to the destination group 208 with the group tag 214 of “work.” Based on the content 204 shared with the content destination 210, the destination group 208, or a combination thereof, the behavior tracker module 1130 can track the content sharing pattern 810 of the content 204.

For a different example, the behavior tracker module 1130 can track the communication history 814 for sharing the content 204. More specifically, the behavior tracker module 1130 can track the delivery method 216 used for sharing the content 204. For example, the content 204 representing business card can be shared by the delivery method 216 of the SMS. For further example, the behavior tracker module 1130 can track the content destination 210, the destination group 208, or a combination thereof where the content 204 was delivered. More specifically, the content 204 representing the business card can be shared to the destination group 208 with the group tag 214 of “clients.” The behavior tracker module 1130 can track that the content 204 of the business card was shared to the destination group 208 of “clients.”

For another example, the behavior tracker module 1130 can track the device usage pattern 812 of FIG. 8 based on the usage of the first device 102. For example, the behavior tracker module 1130 can track how the content management view 202 is being used for sharing the content 204. For a specific example, the behavior tracker module 1130 can track how often the explosion view 704 is being used for viewing the content destination 210 individually. Based on the usage of the first device 102, the behavior tracker module 1130 can track the device usage pattern 812.

The fetcher module 1126 can include a social tracker module 1132. The social tracker module 1132 tracks the social information 802. For example, the social tracker module 1132 can track the social information 802 of the content destination 210, the destination group 208, or a combination thereof. The social tracker module 1132 can track the social information 802 in a number of ways.

For example, the social tracker module 1132 can track the profile information 804 of the content destination 210. More specifically, the social tracker module 1132 can track whether the profile information 804 has been added, deleted, updated, or a combination thereof.

For a different example, the social tracker module 1132 can track the social graph 806 of FIG. 8 of the content destination 210. More specifically, the social tracker module 1132 can track whether the social graph 806 between the plurality of the content destination 210, between the user and the content destination 210, or a combination thereof have changed. For example, the social graph 806 between the user and the content destination 210 can change if the user disassociates with the content destination 210 by excluding the content destination 210 from the destination group 208.

For another example, the social tracker module 1132 can track the event information 808 of FIG. 8 of the destination group 208. More specifically, the destination group 208 can include the plurality of the content destination 210 of family members. The social tracker module 1132 can track the event information 808 representing the birthdays for each of the family members in the destination group 208.

The content delivery system 100 can include a trainer module 1134. The trainer module 1134 generates factors considered by the selector module 1102 for generating the destination group 208. For example, the trainer module 1134 can generate factors considered by the selector module 1102 based on supervised learning, unsupervised learning, or a combination thereof for machine learning process. Details are discussed below.

The trainer module 1134 can include a user specific module 1136. The user specific module 1136 considers factors pertinent for selecting the content destination 210. For example, the user specific module 1136 can consider the user's behavior 602.

The user specific module 1136 can include a specific feature module 1138. The specific feature module 1138 generates a manipulation feature profile 1140. For example, the specific feature module 1138 can generate the manipulation feature profile 1140 based on the user's behavior 602. The manipulation feature profile 1140 can represent an aggregated data pertaining to the content destination 210, the destination group 208, or a combination thereof after being manipulated by the user's behavior 602.

The specific feature module 1138 can generate the manipulation feature profile 1140 in a number of ways. For example, the specific feature module 1138 can generate the manipulation feature profile 1140 based on the communication history 814. For a specific example, the content destination 210 can represent “girlfriend.” The communication history 814 can show that the first device 102 shared the content 204 with the content destination 210 for five hours from 7 PM to 10 AM. The specific feature module 1138 can generate the manipulation feature profile 1140 to include the communication history 814 of five hours and the time of day.

Continuing with the previous example, the content sharing pattern 810 can show that the content destination 210 of “girlfriend” can receive the content type 206 of the digital photograph more than the other instances of the content type 206. The specific feature module 1138 can generate the manipulation feature profile 1140 to include the content sharing pattern 810 of sharing the digital photograph more than other types of the content 204 to the content destination 210.

Further continuing with the previous example, the grouping pattern 608 can indicate the inclusion or the exclusion of the content destination 210 from the destination group 208. More specifically, the content destination 210 of “girlfriend” can initially be included in the destination group 208 with the group tag 214 of “family.” However, after breaking up with the girlfriend, the content destination 210 can be excluded from the destination group 208 of “family” and included in the destination group 208 with the group tag 214 of “acquaintance.” The specific feature module 1138 can generate the manipulation feature profile 1140 to include the grouping pattern 608 of inclusion and exclusion the content destination 210.

The user specific module 1136 can include a specific correlation analyzer module 1142. The specific correlation analyzer module 1142 calculates a user specific classification level 1144. For example, the specific correlation analyzer module 1142 can calculate the user specific classification level 1144 based on comparing a plurality of the manipulation feature profile 1140. The user specific classification level 1144 can represent a level of correlation between the plurality of the manipulation feature profile 1140.

The specific correlation analyzer module 1142 can calculate the user specific classification level 1144 in a number of ways. For example, the specific correlation analyzer module 1142 can calculate the user specific classification level 1144 based on a linear classification algorithm, a non-linear classification algorithm, or a combination thereof. For a specific example, the specific correlation analyzer module 1142 can calculate the user specific classification level 1144 based on support vector machine (SVM), Hidden Markov Model (HMM), or a combination thereof.

More specifically, the specific correlation analyzer module 1142 can calculate the user specific classification level 1144 based on classifying the manipulation feature profile 1140 using the machine learning algorithm. For example, the specific correlation analyzer module 1142 can calculate the user specific classification level 1144 by finding similarities of the user's behavior 602 shared by the plurality of the manipulation feature profile 1140. For a specific example, the specific correlation analyzer module 1142 can calculate the user specific classification level 1144 based on the user's behavior 602 shared between the plurality of the manipulation feature profile 1140.

Continuing with the example, one instance of the manipulation feature profile 1140 can be generated for the content destination 210 of “manager” while another instance of the manipulation feature profile 1140 can be generated for the content destination 210 of “first year engineer.” Both instances of the manipulation feature profile 1140 can share the grouping pattern 608 of being grouped within the destination group 208 with the group tag 214 of “work.” Furthermore, both instances of the manipulation feature profile 1140 can share the same record of the communication history 814 for receiving work emails. However, the manipulation feature profile 1140 for the instance of “manager” can receive the content 204 for a work status report while the manipulation feature profile 1140 of “first year engineer” does not. Thus, the content sharing pattern 810 between the two instances can be unalike.

As a result, the specific correlation analyzer module 1142 can calculate the user specific classification level 1144 representative of a probability value of similarities between the plurality of the manipulation feature profile 1140. The probability value can be represented as rational numbers between “0” to “1.” For example, the user specific classification level 1144 of “1” can represent the plurality of the manipulation feature profile 1140 sharing all of the user's behavior 602. In contrast, the user specific classification level 1144 of “0” can represent the plurality of the manipulation feature profile 1140 sharing none of the user's behavior 602. And for further contrast, the user specific classification level 1144 between “0” and “1” can represent the plurality of the manipulation feature profile 1140 sharing some of the user's behavior 602.

The user specific module 1136 can include an importance calculator module 1146. The importance calculator module 1146 calculates a user specific importance weight 1148. For example, the importance calculator module 1146 can calculate the user specific importance weight 1148 of the user's behavior 602. The user specific importance weight 1148 can represent a significance level of the user's behavior 602.

The importance calculator module 1146 can calculate the user specific importance weight 1148 based on the user specific classification level 1144. For example, the user specific importance weight 1148 can be normalized to rational numbers between “0” to “1.” More specifically, “1” can represent the user specific importance weigh 1148 with the highest weight. In contrast, “0” can represent the user specific importance weigh 1148 with the lowest weight.

For a specific example, as discussed previously, the two instances of the manipulation feature profile 1140 can share the same record the communication history 814 and same pattern of the grouping pattern 608. Further, the communication history 814 and the grouping pattern 608 can be considered valuable, as both instances of the user's behavior 602 having same instances of the user's behavior 602. As a result, the importance calculator module 1146 can calculate the user specific importance weight 1148 for the communication history 814 and the grouping pattern 608 to be “1.” In contrast, the importance calculator module 1146 can calculate the user specific importance weight 1148 for the content sharing pattern 810 to be “0,” as the two instances of the content destination 210 do not share the content sharing pattern 810.

For a different example, the user specific importance weight 1148 can be calculated based on the user's behavior 602 not shared. For example, as discussed previously, the two instances of the manipulation feature profile 1140 can share the same record of the communication history 814 and the same pattern for the grouping pattern 608. However, the content sharing pattern 810 between the two instances of the manipulation feature profile 1140 are unalike. More specifically, the content 204 was shared to the content destination 210 with the destination type 212 of “boss.” Further, the user's behavior 602 that is considered unique can be considered more valuable, as the content sharing pattern 810 was the only instance of the user's behavior 602 unalike. As a result, the importance calculator module 1146 can calculate the user specific importance weight 1148 for the content sharing pattern 810 to be “1” because the content 204 shared was only shared to the content destination 210 who is user's boss.

The user specific module 1136 can include a threshold generator module 1150. The threshold generator module 1150 sets a grouping threshold 1152. The grouping threshold 1152 is defined as a requirement limit considered for generating the destination group 208 to include or exclude the content destination 210. For example, the threshold generator module 1150 can set a grouping threshold 1152 based on the use specific importance weight 1148.

The threshold generator module 1150 can set the grouping threshold 1152 in a number of ways. For example, the threshold generator module 1150 can set the grouping threshold 1152 based on the majority number of the user specific importance weight 1148 marked as “1.” More specifically, if there are seven instances of the user specific importance weight 1148, the threshold generator module 1150 can set the grouping threshold 1152 to require at least four instances of the user specific importance weight of “4.”

For a different example, the threshold generator module 1150 can set the grouping threshold 1152 based on the gesture type 604, the activity pattern 606, or a combination thereof. The grouping threshold 1152 can represent the number of the content destination 210 that could be included within the destination group 208. More specifically, the grouping threshold 1152 can base on the destination dimension 506.

For a specific example, the gesture type 604 can be the pinching gesture to reduce the destination dimension 506 of the destination group 208. More specifically, the boundary size of the destination group 208 can be reduced. The smaller boundary size can indicate a higher requirement for including the content destination 210 within the destination group 208 as less number of the content destination 210 can be included within the smaller boundary. Moreover, the threshold generator module 1150 can set to increase the grouping threshold 1152 based on the destination dimension 506.

For a specific example, the grouping threshold 1152 for the destination group 208 can represent an aggregate total of the user specific importance weight 1148 marked as “1.” Initially, the grouping threshold 1152 for the destination group 208 can represent “4.” However, if the pinching gesture reduces the destination dimension 506, the grouping threshold 1152 can be increased to “5,” setting a higher requirement for the content destination 210 to be included within the destination group 208.

In contrast, the pinching gesture can expand the destination dimension 506 of the destination group 208 to reduce the requirement for including the content destination 210. As a result, the threshold generator module 1150 can set to decrease the grouping threshold 1152 to reduce the requirement for including the content destination 210 within the destination group 208. For a specific example, the grouping threshold 1152 can be decreased from “4” to “3.”

It has been discovered that the content delivery system 100 can set the grouping threshold 1152 to improve efficiency in generating the destination group 208. By adjusting the grouping threshold 1152 based on the gesture type 604, the content delivery system 100 can efficiently include or exclude the content destination 210. As a result, the content delivery system 100 can generate the destination group 208 by filtering the content destination 210 efficiently to allow the user to share the content 204 to the content destination 210 most desired by the user.

For another example, the threshold generator module 1150 can set the grouping threshold 1152 based on the destination dimension 506. For example, the threshold generator module 1150 can set the grouping threshold 1152 for the top side of the destination dimension 506 lower for the content destination 210 representing the older generation of the family member than other instances of the content destination 210. In contrast, the threshold generator module 1150 can set the grouping threshold 1152 for the bottom side of the destination dimension 506 to be lower for the content destination 210 representing the younger generation of the family member than other instances of the content destination 210.

It has been discovered that the content delivery system 100 can improve the selection of the content destination 210 by setting the grouping threshold 1152 per portion of the destination dimension 506. By setting the grouping threshold 1152 per portion of the destination dimension 506, the content delivery system 100 can efficiently include or exclude the content destination 210 based on the dimensional change vector 610. As a result, the content delivery system 100 can generate the destination group 208 that accurately reflects the destination dimension 506 to improve efficiency for selecting the content destination 210 desired.

The trainer module 1134 can include a global module 1154. The global module 1154 considers factors pertinent for selecting the content destination 210. For example, the global module 1154 can consider the destination type 212.

The global module 1154 can include a global feature module 1156. The global feature module 1156 generates a global feature profile 1158. For example, the global feature module 1156 can generate a global feature profile 1158 for the content destination 210. The global feature profile 1158 can represent an aggregated data pertaining to the content destination 210. For example, the global feature module 1156 can generate the global feature profile 1158 based on the destination status 902, the destination type 212, the destination location 904, the user's behavior 602, the social information 802, or a combination thereof.

The global feature module 1156 can generate the global feature profile 1158 in a number of ways. For example, the global feature module 1156 can generate the global feature profile 1158 based on the grouping pattern 608. More specifically, the grouping pattern 608 can indicate whether the content destination 210 was included or excluded within or from the destination group 208 based on the destination status 902, the destination type 212, the destination location 904, or a combination thereof.

For a specific example, the content destination 210 can be included within the destination group 208 because the destination status 902 was “available” or “authorized to connect.” In contrast, the content destination 210 can be excluded from the destination group 208 because the destination status 902 was “unavailable” or “denied access.” For a different example, the content destination 210 can be included within the destination group 208 because the destination location 904 was within the communication path 104 of FIG. 1 of same WiFi network. For another example, the content destination 210 can be excluded from the content destination 210 because the destination type 212 of the content destination 210 can be different from the content destination 210 already within the destination group 208. The global feature module 1156 can generate the global feature profile 1158 to include the factors, such as the destination status 902, the destination location 904, or a combination thereof, that determined the inclusion or the exclusion of the content destination 210.

The generation of the global feature profile 1158 can also base on the grouping pattern 608 that considered the social information 802. For example, the content destination 210 can be included within the destination group 208 because the content destination 210 that just joined can share the profile information 804, such as the same education information, as the content destination 210 already in the destination group 208. For a different example, the content destination 210 can be excluded from the destination group 208 based on the social graph 806 that is not within third degree of separation.

The global module 1154 can include a global correlation analyzer module 1160. The global correlation analyzer module 1160 calculates a global classification level 1162. For example, the global correlation analyzer module 1160 can calculate the global classification level 1162 based on comparing a plurality of the global feature profile 1158. The global classification level 1162 can represent a level of correlation between the plurality of the global feature profile 1158.

The global correlation analyzer module 1160 can calculate the global classification level 1162 in a number of ways. For example, the global correlation analyzer module 1160 can calculate the global classification level 1162 based on a linear classification algorithm, a non-linear classification algorithm, or a combination thereof. For a specific example, the global correlation analyzer module 1160 can calculate the global classification level 1162 based on support vector machine (SVM), Hidden Markov Model (HMM), or a combination thereof.

More specifically, the global correlation analyzer module 1160 can calculate the global classification level 1162 based on classifying the global feature profile 1158 using the machine learning algorithm. For example, the global correlation analyzer module 1160 can calculate the global classification level 1162 by finding similarities of the user's behavior 602 shared by the plurality of global feature profile 1158. For a specific example, the global correlation analyzer module 1160 can calculate the global classification level 1162 based on the user's behavior 602 shared between the plurality of the global feature profile 1158.

Continuing with the example, the global correlation analyzer module 1160 can calculate the global classification level 1162 based on the destination status 902, the destination type 212, the destination location 904, the user's behavior 602, the social information 802, or a combination thereof frequently shared between the plurality of the global feature profile 1158. For example, all instances of the content destination 210 within the destination group 208 can have the profile information 804 of “Samsung” as work experience. In contrast, one instance of the content destination 210 can have the profile information 804 of “married” for marital status. As a result, the global correlation analyzer module 1160 can calculate the global classification level 1162 representative of a probability value of similarities between the plurality of the global feature profile 1158. The probability value can be represented similarly as the user specific classification level 1144. For a specific example, the profile information 804 of “Samsung” can represent as “1” while the profile information 804 “of “married” for marital status can be “0.”

For a different example, most instances of the content destination 210 within the destination group 208 can have the social graph 806 of one degree of separation. However, one instance of the content destination 210 can have the social graph 806 of three degrees of separation. Moreover, the content destination 210 with the social graph 806 of three degrees of separation can have the destination type 212 of “financier.” As a result, the global correlation analyzer module 1160 can calculate the global classification level 1162 for the social graph 806 of one degree of separation as “1” while the profile information 804 of “financier” as “0” within the destination group 208.

The global module 1154 can include a weight classifier module 1164. The weight classifier module 1164 calculates an adjustment weight 1166. The weight classifier module 1164 can calculate the adjustment weight 1166 based on the global classification level 1162. The adjustment weight 1166 can represent a factor to be considered for adjusting the importance of the destination status 902, the destination type 212, the destination location 904, the user's behavior 602, the social information 802, or a combination thereof for generating the destination group 208. The adjustment weigh 1166 can be normalized to rational numbers similarly to the user specific importance weight 1148.

Continuing with the previous example, the weight classifier module 1164 can calculate the adjustment weight 1166 for the profile information 804 of “Samsung” to be “1” based on the global classification level 1162 of “1.” In contrast, the weight classifier module 1164 can calculate the adjustment weight 1166 for the profile information 804 of “married” to be “0 based on the global classification level 1162 of “0.”

For a different example, also continuing from the previous example, the weight classifier module 1164 can calculate the adjustment weight 1166 for the profile information 804 of “financier” to be “1” even though the global classification level 1162 was “0.” In contrast, the weight classifier module 1164 can calculate the adjustment weight 1166 for the social graph 806 of “one degree of separation” to be “0” even though the global classification level 1162 was “1.” The weight classifier module 1164 can calculate the adjustment weight 1166 to be “1” for the profile information 804 because the content destination 210 without the social graph 806 of one degree of separation was also included within the destination group 208.

For another example, the weight classifier module 1164 can calculate the adjustment weight 1166 based on the user specific importance weight 1148. For example, the communication history 814 can have the user specific importance weight 1148 of “1.” As a result, the weight classifier module 1164 can calculate the adjustment weight 1166 for the communication history 814 to be “1.”

For a different example, the weight classifier module 1164 can calculate the adjustment weight 1166 based on the event information 808. For example, the weight classifier module 1164 can calculate the adjustment weight 1166 for the event information 808 that is upcoming higher than the event information 808 that is far in the future.

It has been discovered that the content delivery system 100 can calculate the adjustment weight 1166 to accurately reflect the factors important to the user of the content delivery system 100. By calculating the adjustment weight 1166 for each of the factors, such as the destination status 902, the destination type 212, the destination location 904, the user's behavior 602, and the social information 802, the content delivery system 100 can select the content destination 210 most suitable for the user. As a result, the content delivery system 100 can improve the efficiency and accuracy for selecting the content destination 210.

For illustrative purposes, the content delivery system 100 is shown with the threshold generator module 1150 setting the grouping threshold 1152 based on the user specific importance weight 1148, the gesture type 604, or a combination thereof, although it is understood that the threshold generator module 1150 can be operated differently. For example, the threshold generator module 1150 can set the grouping threshold 1152 based on the adjustment weight 1166. More specifically, the threshold generator module 1150 can set the grouping threshold 1152 based on the number of the adjustment weight 1166 marked as “1.”

For illustrative purposes, the content delivery system 100 is shown with the discovery module 1101 discovering the content destination 210, although it is understood that the discovery module 1101 can be operated differently. The discovery module 1101 can include an authenticator module 1168. The authenticator module 1168 tracks the content destination 210 discovered. For example, the authenticator module 1168 can update the content destination 210 available by tracking the destination status 902 via the first control interface 1022. For another example, if the content destination 210 changes the destination location 904, the authenticator module 1168 can update the destination location 904. The authenticator module 1168 can send the destination status 902, the destination location 904, or a combination thereof to the selector module 1102. Details regarding the authenticator module 1168 tracking the content destination 210 discovered will be discussed below.

For illustrative purposes, the content delivery system 100 is shown with the initialization module 1104 of the selector module 1102 determining the content destination 210, the destination group 208, or a combination thereof, although it is understood that the selector module 1102 can be operated differently. For example, the selector module 1102 can generate the destination group 208 based on the adjustment weight 1166, the grouping threshold 1152, or a combination thereof.

The selector module 1102 can include the pruning module 1106. The pruning module 1106 eliminates the content destination 210. For example, the pruning module 1106 can eliminate the content destination 210 from consideration for including in the destination group 208. For example, the pruning module 1106 can eliminate the content destination 210 based on the adjustment weight 1166 failing to meet or exceed the grouping threshold 1152. In other words, the pruning module 1106 can identify the content destination 210 based on the adjustment weight 1166 meeting or exceeding the grouping threshold 1152. More specifically, if the grouping threshold 1152 requires the content destination 210 to have majority number of the adjustment weight 1166 to be high, the content destination 210 with minority number of the adjustment weight 1166 will fail to meet the grouping threshold 1152.

For a different example, the pruning module 1106 can eliminate the content destination 210 based on the grouping pattern 608. More specifically, if the content destination 210 was excluded from the destination group 208 with the group tag 214 of “friend,” the pruning module 1106 can designate the content destination 210 excluded as a non-candidate for including into the destination group 208 of “friend.”

The selector module 1102 can include the priority module 1108. The priority module 1108 prioritizes the content destination 210. For example, the priority module 1108 can prioritize the content destination 210 for including the content destination 210 in the destination group 208. For example, the priority module 1108 can generate the destination priority 510 of FIG. 5 based on the adjustment weight 1166.

The priority module 1108 can generate the destination priority 510 in a number of ways. For example, the priority module 1108 can prioritize the content destination 210 based on the adjustment weight 1166. The higher the adjustment weight 1166, the priority module 1108 can give a higher rank for the content destination 210 to be included in the destination group 208.

For a different example, the priority module 1108 can generate the destination priority 510 based on the grouping pattern 608. More specifically, the destination group 208 can represent “study group.” The content destination 210 can represent “classmate.” The grouping pattern 608 can indicate that the content destination 210 was included in the destination group 208 previously. The priority module 1108 can prioritize the inclusion of the content destination 210 of “classmate” into the destination group 208 of “study group.”

The selector module 1102 can include the destination selector module 1110. The destination selector module 1110 selects the content destination 210. For example, the destination selector module 1110 can select the content destination 210 to be included in the destination group 208. For example, the destination selector module 1110 can select the content destination 210 based on the destination priority 510. More specifically, the destination selector module 1110 can select the content destination 210 with the higher of the destination priority 510 prior to selecting the content destination 210 with lower of the destination priority 510.

For another example, the destination selector module 1110 can select the content destination 210 based on the destination type 212. More specifically, the destination selector module 1110 can determine to share the content 204 with the content destination 210 if the content destination 210 has the same instance of the destination type 212 as the first device 102.

The selector module 1102 can include the grouping module 1112. The grouping module 1112 generates the destination group 208. For example, the grouping module 1112 can generate the destination group 208 based on the destination priority 510, the destination characteristic 502 of FIG. 5, the grouping threshold 1152, or a combination thereof. For further example, the grouping module 1112 can generate the destination group 208 based on the user's behavior 602, the social information 802, or a combination thereof.

The grouping module 1112 can generate the destination group 208 in a number of ways. The grouping module 1112 can generate the destination group 208 based on the destination characteristic 502, the destination priority 510, or a combination thereof. For example, the destination priority 510 can indicate the destination appearance 504 of FIG. 5 of the destination group 208. For a specific example, the destination priority 510 of high can represent the color of “green” as discussed previously. The grouping module 1112 can generate the destination group 208 with the destination appearance 504 of “green” based on the destination priority 510 of high.

The grouping module 1112 can generate the destination group 208 based on extrapolation of the grouping pattern 608. For example, the grouping pattern 608 in the past can indicate that the destination group 208 of “alumni” can include the content destination 210 with the profile information 804 of “Stanford University” as the education information. Furthermore, the grouping module 1112 can generate the destination group 208 with the certain size of the destination dimension 506 based on the number of the content destination 210 with the profile information 804. More specifically, if the content destination 210 with the profile information 804 of “Stanford University” as five instances, the grouping module 1112 can generate the destination group 208 with the destination dimension 506 that fits five instances of the content destination 210.

It has been discovered that the content delivery system 100 can generate the destination group 208 with the content destination most desired by the user. Based on the grouping pattern 608, the content delivery system 100 can extrapolate the content destination 210 that should be included or excluded from the destination group 208. As a result, the content delivery system 100 can filter the content destination 210 undesired by the user to improve efficiency for sharing the content 204.

The grouping module 1112 can generate the destination group 208 based on the social information 802. For example, the social information 802 can represent the event information 808 of “annual company party.” The content destination 210 can represent the employee of the company. The grouping module 1112 can generate the destination group 208 based on the event information 808 to include the content destination 210 to include in the destination group 208. In contrast, the event information 808 can represent “board meeting.” Since the content destination 210 is an employee and not a board member, the grouping module 1112 can generate the destination group 208 that excludes the content destination 210.

It has been discovered that the content delivery system 100 can generate the destination group 208 that accurately reflects the social dynamic within the user's social network. Based on the social information 802, the content delivery system 100 can generate the destination group 208 that accurately reflects the user's social relationship. As a result, the content delivery system 100 can include or exclude the content destination 210 relevant to the user's social relationship to improve efficiency for sharing the content 204.

The grouping module 1112 can generate the destination group 208 based on the grouping threshold 1152. More specifically, the grouping module 1112 can generate the destination group 208 based on the dimensional change vector 610, which changed the grouping threshold 1152, for including or excluding the content destination 210.

As discussed previously, the grouping threshold 1152 can change based on the direction of the dimensional change vector 610. For example, the top side of the circle can be expanded to lower the grouping threshold 1152 for including the older generation of the family. As a result, the grouping module 1112 can generate the destination group 208 to include more instances of the content destination 210 representing the older generation of the family.

It has been discovered that the content delivery system 100 can generate the destination group 208 that accurately reflects the change in the grouping threshold 1152 caused by the dimensional change vector 610. By factoring the dimensional change vector 610 generated by the gesture type 604, the content delivery system 100 can control the generation of the grouping threshold 1152 to improve the inclusion or the exclusion of the content destination 210. As a result, the content delivery system 100 can generate the destination group 208 reflective of the gesture type 604 for an accurate selection of the content destination 210.

For illustrative purposes, the content delivery system 100 is shown with the dispatcher module 1114 displaying the content destination 210, the destination group 208, or a combination thereof, although it is understood that the dispatcher module 1114 can be operated differently. For example, the dispatcher module 1114 can configure the delivery method 216.

The dispatcher module 1114 can include the sharing configurator module 1124. The sharing configurator module 1124 configures the delivery method 216. For example, the sharing configurator module 1124 can configure the delivery method 216 for sending the content 204 to the content destination 210.

The sharing configurator module 1124 can configure the delivery method 216 in a number of ways. For example, the sharing configurator module 1124 can configure the delivery method 216 based on the user's behavior 602. More specifically, the sharing configurator module 1124 can configure the delivery method 216 based on the activity pattern 606.

For a specific example, the content sharing pattern 810 for the content type 206 representing the digital photograph can be shared via email to the destination group 208 with the group tag 214 of “family.” Based on the content sharing pattern 810, the sharing configurator module 1124 can configure the delivery method 216 for sharing the content 204 of the digital photograph to the destination group 208 of “family” to be via email.

For another example, the device usage pattern 812 shows that the content type 206 representing the PDF was shared to the content destination 210 with the destination type 212 of stationary device with the destination location 904 of user's home. Further, the device usage pattern 812 also shows the PDF is shared each night at 8 PM via FTP. Based on the device usage pattern 812, the sharing configurator module 1124 can configure the delivery method 216 for sharing the content 204 of the PDF to the content destination 210 representing the stationary device via FTP at 8 PM.

For another example, the communication history 814 indicates that the content 204 shared to the destination group 208 with the group tag 214 of “work” via email and SMS. Further, the frequency of the content 204 shared via email is greater than shared via SMS. Based on the communication history 814, the sharing configurator module 1124 can configure the delivery method 216 for sharing the content 204 to the destination group 208 with the group tag 214 of “work” to be via email.

The physical transformation for tracking the destination status 902 and the destination location 904 results in movement in the physical world, such as people using the first device 102, based on the operation of the content delivery system 100. As the movement in the physical world occurs, the movement itself creates additional information that is converted back into the adjustment weight 1166 for selecting the content destination 210 and generating the destination group 208 for the continued operation of the content delivery system 100 and to continue movement in the physical world.

The first software 1026 of FIG. 10 of the first device 102 of FIG. 10 can include the content delivery system 100. For example, the first software 1026 can include the discovery module 1101, the selector module 1102, the dispatcher module 1114, the fetcher module 1126, and the trainer module 1134.

The first control unit 1012 of FIG. 10 can execute the first software 1026 for the selector module 1102 to generate the destination group 208. The first control unit 1012 can execute the first software 1026 for the dispatcher module 1114 to change the content management view 202. The first control unit 1012 can execute the first software 1026 for the fetcher module 1126 to track the grouping pattern 608. The first control unit 1012 can execute the first software 1026 for the trainer module 1134 to generate the adjustment weight 1166, the grouping threshold 1152, or a combination thereof.

The second software 1042 of FIG. 10 of the second device 106 of FIG. 10 can include the content delivery system 100. For example, the second software 1042 can include the discovery module 1101, the selector module 1102, the dispatcher module 1114, the fetcher module 1126, and the trainer module 1134.

The second control unit 1034 of FIG. 10 can execute the second software 1042 for the selector module 1102 to generate the destination group 208. The second control unit 1034 can execute the second software 1042 for the dispatcher module 1114 to change the content management view 202. The second control unit 1034 can execute the second software 1042 for the fetcher module 1126 to track the grouping pattern 608. The second control unit 1034 can execute the second software 1042 for the trainer module 1134 to generate the adjustment weight 1166, the grouping threshold 1152, or a combination thereof.

The content delivery system 100 can be partitioned between the first software 1026 and the second software 1042. For example, the second software 1042 can include the discovery module 1101, the selector module 1102, the fetcher module 1126, and the trainer module 1134. The second control unit 1034 can execute modules partitioned on the second software 1042 as previously described.

The first software 1026 can include the dispatcher module 1114. Based on the size of the first storage unit 1014 of FIG. 10, the first software 1026 can include additional modules of the content delivery system 100. The first control unit 1012 can execute the modules partitioned on the first software 1026 as previously described.

The first control unit 1012 can operate the first communication unit 1016 of FIG. 10 to send the gesture type 604 to the second device 106. The first control unit 1012 can operate the first software 1026 to operate the location unit 1020. The second communication unit 1036 of FIG. 10 can send the destination group 208 to the first device 102 through the communication path 104 of FIG. 10.

The content delivery system 100 describes the module functions or order as an example. The modules can be partitioned differently. For example, the fetcher module 1126 and the trainer module 1134 can be combined. Each of the modules can operate individually and independently of the other modules.

Furthermore, data generated in one module can be used by another module without being directly coupled to each other. For example, the selector module 1102 can receive the grouping pattern 608 from the fetcher module 1126. The discovery module 1101, the selector module 1102, the dispatcher module 1114, the fetcher module 1126, and the trainer module 1134 can be implemented in as hardware accelerators (not shown) within the first control unit 1012 or the second control unit 1034, or can be implemented in as hardware accelerators (not shown) in the first device 102 or the second device 106 outside of the first control unit 1012 or the second control unit 1034.

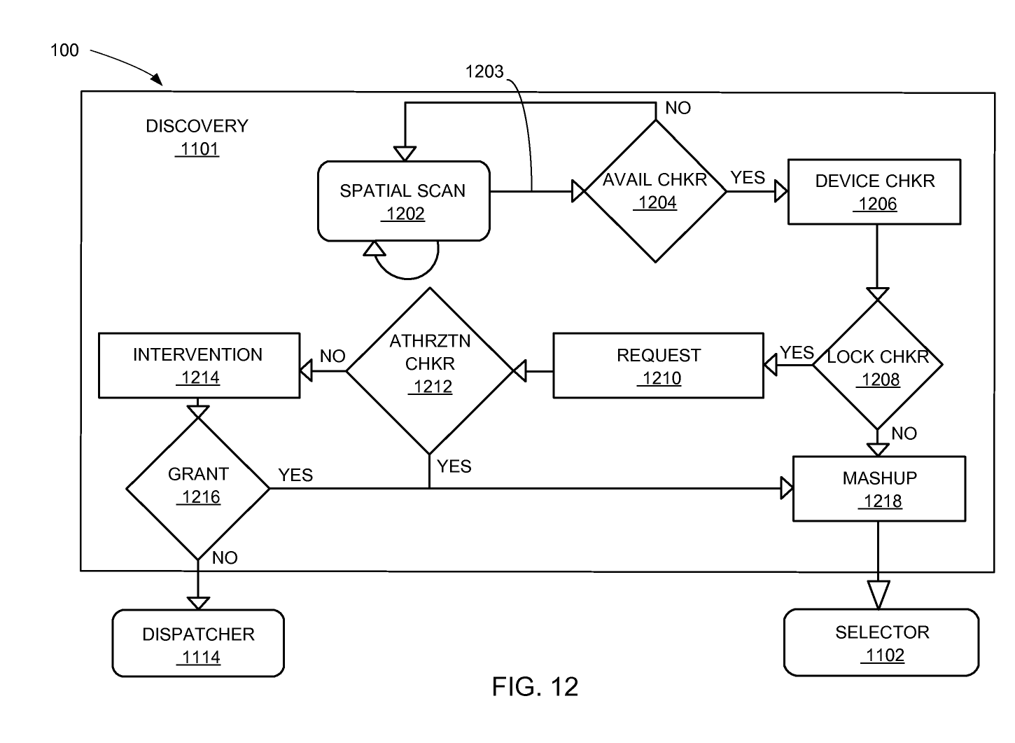

Referring now to FIG. 12, therein is the discovery module 1101 discovering the content destination 210 of FIG. 2 for sharing the content 204 of FIG. 2. The authenticator module 1168 of FIG. 11 can apply the same process as the discovery module 1101 to track the discovery of the content destination 210.

The discovery module 1101 can include a spatial scan module 1202. The spatial scan module 1202 scans the communication path 104 of FIG. 1. For example, the spatial scan module 1202 can scan the communication path 104 via the first control interface 1022 of FIG. 10 to discover the content destination 210. More specifically, the spatial scan module 1202 can scan the communication path 104 to discover an internet protocol (IP) address, a wireless access point (WAP), or a combination thereof to detect live network connection of the content destination 210.

For another example, the spatial scan module 1202 can discover the content destination 210 based on the destination location 904 of FIG. 9. The spatial scan module 1202 can initially configure the content delivery system 100 to identify the content destination 210 within a predefined vicinity 1203. The predefined vicinity 1203 can represent a physical distance from the first device 102 of FIG. 1 to the content destination 210. For example, the predefined vicinity 1203 can represent 20-meter radius from the first device 102 to one instance of the content destination 210. Via the location unit 1020 of FIG. 10, the spatial scan module 1202 can discover whether the destination location 904 of the content destination 210 is within the predefined vicinity 1203.

The discovery module 1101 can include an availability checker module 1204, which can be coupled to the spatial scan module 1202. The availability checker module 1204 checks whether the content destination 210 is available for connection. For example, the availability checker module 1204 can send, via the first control interface 1022, a Simple Network Management Protocol (SNMP)/Internet Control Message Protocol (ICMP) request to check the availability. The content destination 210 can send a response if the content destination 210 is available for connection. For another example, the content delivery system 100 can connect the first device 102 to the content destination 210 if the content destination 210 is within the predefined vicinity 1203. If the connection is possible with the content destination 210, the availability checker module 1204 can determine the content destination 210 is available for sharing the content 204.

The discovery module 1101 can include a device checker module 1206, which can be coupled to the availability checker module 1204. The device checker module 1206 checks for an identification and a capability of the content destination 210. For example, if the content destination 210 is available for connection, the device checker module 1206 can check for the identification and the capability of the content destination 210 representing the electronic device. For further example, the device checker module 1206 can send the GET command of hypertext transfer protocol (HTTP) to retrieve the identification and the capability of the device.

For another example, the device checker module 1206 can discover the content destination 210 based on the destination type 212 of FIG. 2. The first device 102 can represent a Samsung Galaxy™ smartphone. The destination type 212 for one instance of the content destination 210 can also be a Samsung Galaxy™ smartphone. The destination type 212 can be determined based on the GET command discussed above. The destination type 212 for another instance of the content destination 210 can be iPhone™ smartphone.

The discovery module 1101 can include a lock checker module 1208, which can be coupled to the device checker module 1206. The lock checker module 1208 determines whether the content destination 210 is locked or not. For example, the lock checker module 1208 can invoke a software method, such as “ApplicationManager.isSystemLocked( )”™, to determine if the content destination 210 is locked. The lock checker module 1208 can receive the destination status 902 of FIG. 9 of “locked” or “unlocked” from the content destination 210.

The discovery module 1101 can include a request module 1210, which can be coupled to the lock checker module 1208. The request module 1210 authenticates the first device 102 and requests for access to the content destination 210. For example, if the content destination 210 is locked, the request module 1210 can perform an authentication and an access request using the OAuth™ protocol.

The discovery module 1101 can include an authorization checker module 1212, which can be coupled to the request module 1210. The authorization checker module 1212 checks for authorization. For example, the authorization checker module 1212 can check whether the content destination 210 granted authorization for the first device 102 to connect to the content destination 210. The authorization checker module 1212 can receive an OAuth Token™ to determine whether first device 102 received authorization to connect to the content destination 210. More specifically, the authorization checker module 1212 can receive the destination status 902 of “authorized” or “unauthorized” from the content destination 210.

The discovery module 1101 can include an intervention module 1214, which can be coupled to the authorization checker module 1212. The intervention module 1214 requests the content destination 210 to allow access for the first device 102 to connect. For example, SNS, such as Facebook™ or LinkedIn™, can receive a request from the first device 102 for connection to establish a social network relationship with the content destination 210. The recipient, such as the content destination 210, of the request can grant or deny the request for connection.

The discovery module 1101 can include a grant module 1216, which can be coupled to the intervention module 1214. The grant module 1216 grants access to the first device 102 to establish connection with the content destination 210. For example, the grant module 1216 can grant access based on whether the recipient discussed above granted or denied the request by the first device 102. More specifically, the grant module 1216 can receive the destination status 902 of “granted” or “denied” from the content destination 210. If the request was denied, the grant module 1216 can send a denied request notification to the dispatcher module 1114 to be displayed on the first device 102.

The discovery module 1101 can include a mashup module 1218, which can be coupled to the lock checker module 1208, the authorization checker module 1212, the grant module 1216, or a combination thereof. The mashup module 1218 aggregates the data deduced within the discovery module 1101.

For example, if the destination status 902 is “unlocked,” the mashup module 1218 can send the identification of the content destination 210 to the selector module 1102 to consider whether to share the content 204. For another example, if the destination status 902 is “authorized,” the mashup module 1218 can send the identification of the content destination 210 to the selector module 1102 to consider whether to share the content 204. For a different example, if the destination status 902 is “granted,” the mashup module 1218 can send the identification of the content destination 210 to the selector module 1102 to consider whether to share the content 204.

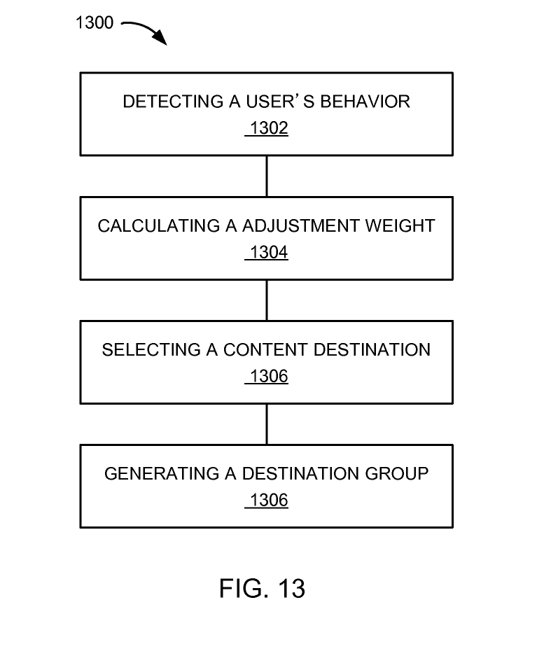

Referring now to FIG. 13, therein is shown a flow chart of a method 1300 of operation of the content delivery system 100 in an embodiment of the present invention. The method 1300 includes: detecting a user's behavior in a block 1302; calculating an adjustment weight based on the user's behavior in a block 1304; selecting a content destination based on the adjustment weight for sharing a content to the content destination in a block 1306; and generating a destination group based on the content destination for displaying on a device in a block 1308.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the embodiment of the present invention is that it valuably supports and services the historical trend of reducing costs, simplifying systems, and increasing performance. These and other valuable aspects of the embodiment of the present invention consequently further the state of the technology to at least the next level.

While the invention has been described in conjunction with a specific best mode, it is to be understood that many alternatives, modifications, and variations will be apparent to those skilled in the art in light of the a foregoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a content delivery system comprising:
detecting a user's behavior;
calculating an adjustment weight based on the user's behavior;
selecting a content destination based on the adjustment weight for sharing a content to the content destination; and
generating a destination group based on the content destination for displaying on a device.

2. The method as claimed in claim 1 further comprising setting a grouping threshold based on the user's behavior for identifying the content destination to be included or excluded in the destination group.

3. The method as claimed in claim 1 wherein selecting the content destination includes selecting the content destination based on a grouping threshold for identifying the content destination to be included or excluded in the destination group.

4. The method as claimed in claim 1 wherein calculating the adjustment weight includes calculating the adjustment weight based on a social information for selecting the content destination.

5. The method as claimed in claim 1 further comprising calculating a destination priority based on the adjustment weight for selecting the content destination.

6. A method of operation of a content delivery system comprising:
detecting a user's behavior;
calculating an adjustment weight based on the user's behavior;
setting a grouping threshold based on the user's behavior;
selecting a content destination based on the adjustment weight, the grouping threshold, or a combination thereof for sharing a content to the content destination; and
generating a destination group based on the content destination for displaying on a device.

7. The method as claimed in claim 6 wherein:
detecting the user's behavior includes detecting a dimensional change vector for changing a destination dimension of the destination group; and
generating the destination group includes generating the destination group based on the dimensional change vector for including or excluding the content destination.

8. The method as claimed in claim 6 wherein setting the grouping threshold includes setting the grouping threshold based on a gesture type for including the content destination in the destination group.

9. The method as claimed in claim 6 wherein generating the destination group includes generating the destination group based on a social information for including the content destination in the destination group.

10. The method as claimed in claim 6 wherein calculating the adjustment weight includes calculating the adjustment weight based on a device status for selecting the content destination.

11. A content delivery system comprising:
a dispatcher module for detecting a user's behavior;
a trainer module, coupled to the dispatcher module, for calculating an adjustment weight based on the user's behavior;
a destination selector module, coupled to the trainer module for selecting a content destination based on the adjustment weight for sharing a content to the content destination; and
a grouping module, coupled to the destination selector module, for generating a destination group based on the content destination for displaying on a device.

12. The system as claimed in claim 11 wherein the trainer module includes a threshold generator module for setting a grouping threshold based on the user's behavior for identifying the content destination to be included or excluded in the destination group.

13. The system as claimed in claim 11 wherein the destination selector module is for selecting the content destination based on a grouping threshold for identifying the content destination to be included or excluded in the destination group.

14. The system as claimed in claim 11 wherein the trainer module includes a weight classifier module for calculating the adjustment weight based on a social information for selecting the content destination.

15. The system as claimed in claim 11 further comprising a priority module, coupled to the destination selector module, for generating a destination priority based on the adjustment weight for selecting the content destination.

16. The system as claimed in claim 11 wherein:
the trainer module is for setting a grouping threshold based on the adjustment weight; and
the destination selector module is for selecting a content destination based on the adjustment weight, the grouping threshold, or a combination thereof.

17. The system as claimed in claim 16 wherein:
the dispatcher module includes a behavior detector module for detecting a dimensional change vector for changing a destination dimension of the destination group; and
the grouping module is for generating the destination group based on the dimensional change vector for including or excluding the content destination.

18. The system as claimed in claim 16 wherein the trainer module includes a threshold generator module for setting the grouping threshold based on a gesture type for including the content destination in the destination group.

19. The system as claimed in claim 16 wherein the grouping module is for generating the destination group based on a social information for including the content destination in the destination group.

20. The system as claimed in claim 16 wherein the trainer module includes a weight classifier module for calculating the adjustment weight based on a device status for selecting the content destination.
